(19) United States
(12) Patent Application Publication
(10) Pub. No.: US 2017/0020762 A1
(43) Pub. Date: Jan. 26, 2017

(54) Method for Treating and Correcting Gait Related Joint Dysfunctions

(71) Applicant: Andrew Swanson, Kingston, WA (US)

(72) Inventor: Andrew Swanson, Kingston, WA (US)

(21) Appl. No.: 15/079,437

(22) Filed: Mar. 24, 2016

Related U.S. Application Data
(63) Continuation-in-part of application No. 14/882,038, filed on Oct. 13, 2015.
Application No. 14/882,038 is a division of application No. 13/596,640, filed on Aug. 28, 2012.
(60) Provisional application No. 61/368,231, filed on Jul. 27, 2010.

(51) Int. Cl. A61H 1/00; A61G 13/00

(52) U.S. Cl. CPC A61H 1/008; A61G 13/009; A61H 2201/1253

(57) ABSTRACT

A method for correcting various dysfunctional joints on a human body using manual manipulation by an practitioner, comprising the steps of first determining the dominant and non-dominant side of a patient's body, manually administering to the human body a primary treatment cycle that includes nine functional joint manipulations each applied on one treatment session sequentially from patient's dominant side foot, the dominant-side knee, the dominant-side hip, the dominant-side pubic symphysis, the dominate side sacrotuberous ligament, the contralateral proximal clavicle, the contralateral shoulder, the contralateral elbow, and ending at the contralateral wrist. After the primary treatment cycle is completed, a secondary treatment cycle comprising nine functional joint manipulations each applied on one treatment session visit sequentially beginning at the non-dominate foot and moving upward and towards the patient's upper body contralateral shoulder, arm and wrist. After the secondary treatment cycle is completed, the primary treatment cycle is repeated.

This is a continuation in part application that claims the filing date benefit of pending U.S. Division patent application (application Ser. No. 14/882,038) filed on Oct. 13, 2015, that claims the filing date benefit of U.S. utility patent application (application Ser. No. 13/192,424) filed on Jul. 27, 2011, abandoned, which claims the filing date benefit of U.S. provisional patent application (Application No. 61/368,231) filed on Jul. 27, 2010.

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention

The present invention relates to systems and methods for treating patients by administration of a predetermined sequence of physical manipulations to the patient's body. More particularly, the present invention provides long-term resolution of symptoms and joint dysfunction by correcting movement dysfunctions of certain joints in the patient's body, including manipulation of a predetermined sequence of joints in the patient's extremities. Disciplines inclined to utilize embodiments of the present invention include chiropractic, naturopaths, sports medicine, physical therapy, professional and collegiate trainers, and applications to veterinary medicine.

2. Description of the Related Art

Since the late 1800's, the chiropractic health care discipline has provided treatment options to patients to address a wide variety of disease processes and neuro-musculoskeletal conditions. The treatment has often focused on correcting “subluxations” through many manipulation techniques, some of which may be performed entirely by controlled administration of force by the chiropractic physician, and others through assistance of certain mechanical and/or electrical devices. As defined by the World Health Organization, a chiropractic subluxation constitutes “a lesion or dysfunction in a joint or motion segment in which alignment, movement integrity and/or physiological function are altered, although contact between joint surfaces remains intact. It is essentially a functional entity, which may influence bio-mechanical and neural integrity.”

Common chiropractic patient management involves spinal manipulation and other manual therapies to the joints and soft tissues. Spinal manipulation, which chiropractors may also call “spinal adjustment” or “chiropractic adjustment,” is the most common treatment used in chiropractic care to remove nerve interference, restore patient overall health, and also relieve pain. Complementary treatments may also include rehabilitative exercises, health promotion, electrical modalities, complementary procedures, and lifestyle counseling.

An array of diagnostic methods and treatment techniques were developed in the chiropractic profession to identify and correct chiropractic subluxations. Popular chiropractic treatment methods include: Diversified, Gonstead, SOT, Motion Palpation, Applied Kinesiology, Activator Method, Grostic, DNFT, Atlas Orthoginal, and Toftness. Some techniques start from the upper spine and work towards the lower spine, others from the lower spine to upper spine. Some focus on the upper and others focus on the lower spine. All chiropractic techniques involve random treatments of the spine.

What is needed is a chiropractic treatment method that provides for expedited patient healing with a predicable number of treatments. What is also needed is a chiropractic treatment method that provides for reduction of sports injuries through coordinated adjustment of body structures. Furthermore, a method is needed to enhance freedom of motion in motion-absorbing joints and components of the body to promote wellness and provide for long-term resolution and prevention of subluxations.

### SUMMARY OF THE INVENTION

There is provided a system and method for treating a patient by administering a predetermined treatment sequence of restorative joint adjustments to a patient's body.

The study of the human gait cycle shows that beginning with heel strike, feet adapt to the ground surface walked upon, and likewise, the feet absorb the shock of each step. This absorbing of shock slows down the ground reactive force so the surrounding tissues of the leg can further dampen it. The result is reduced stress on the musculoskeletal system.

The absorption of force depends on proper joint function throughout the foot and ankle. These joints must move within their ranges to efficiently absorb shock. Unfortunately, the average foot and ankle joints do not move within their ranges, since they experience an abundance of joint dysfunction.

This joint dysfunction is caused by modern-day walking surfaces. Before paved walkways and solid flooring were commonplace, humans used to walk on irregular surfaces such as dirt, sand, moss, rocks, and tree roots. The normal deformation of the feet when traversing these uneven surfaces promoted more flexibility in the joints of the foot and ankle while walking. Natural surfaces were often more cushioned, which further reduced the stress coupled to the human body from walking.

The surfaces we now walk on, concrete, asphalt, hardwood, tile and marble, are less forgiving and more rigid. These flat, hard surfaces do not promote joint flexibility, rather they promote joint dysfunction. Without proper joint function the foot and ankle cannot efficiently absorb and dissipate ground reactive forces. This leads to pathological amounts of stress repeatedly travelling throughout the musculoskeletal system. Further, to stabilize itself, the spine tightens muscles and compresses joints to adapt to this continuous force. The result is a degenerating spine that lacks function and mobility, creating an environment for injury.

Joints in the sacroiliac region react to oncoming force by compression of the sacrum on the ileum. This takes place through surrounding muscle contractions compressing the sacroiliac joint together, as the body “braces” for impact. Studies suggest that the body attempts to compress the joints together to enhance stability.

Underlying theories of the present invention are similarly founded on these principles: modern-day humans are surrounded by an abundance of flat, hard, and mostly horizontal walking surfaces. Walking and running in this environment cause joints in the feet and ankles to become dysfunctional. Humans no longer absorb the shock from ground reactive forces efficiently. Every day, just from walking and related activities, approximately 700 tons of unimpeded force travel up legs, into the pelvis and spine. The human body compresses joints together throughout the musculoskeletal structure to provide stability. This compression of joints involves the feet, ankles, knees, hips, pelvis, spine, shoulders, elbows and wrists.

In the present model of chiropractic, a practitioner will examine a new patient's spine and determine multiple joint dysfunctions, or subluxations. Random adjustments will be administered to the patient's spine based on a specific or combination of chiropractic techniques the particular doctor practices. The patient will leave the clinic and return to the surrounding “hardscape” which promotes further bracing and joint compression. With little surprise, the patient returns for treatment with the same joint dysfunction. The traditional reasoning of the chiropractic profession is repetitive, long term treatment is necessary to correct a long standing condition.

Methods and systems of the present invention address the underlying issues that arise from the patient's traversal of surrounding “hardscape” surfaces. In one embodiment, joint dysfunctions within the gait cycle can be corrected to allow for more efficient transfer of forces, less bracing, and reduced joint compressions. When normal motion is restored to the foot, the improved strike force handling of body structures allows the spine to flex and operate normally again, restoring normal nerve supply and joint function throughout the body.

Methods of the present invention were developed to restore normal function by applying certain treatments in a specific order. The developed methods and systems of the present invention will allow the patient's body to respond favorably to a “pattern” of functional joint manipulations with an automatic correction of joint dysfunction. In a preferred embodiment, three treatment cycles are used, each comprising nine functional joint manipulations, with each applied in one treatment session sequentially by the practitioner that follows the natural shockwave that propagates from the striding foot impacting the ground and travels up the leg through the pelvis and to the opposite clavicle, down the opposite arm and to the opposite wrist. An individual usually uses the dominate leg to initiate a stride. The first cycle, known as a ‘primary treatment cycle’, comprises nine functional joint manipulations beginning on the patient's dominate leg and moves upward on the dominate leg and then to the contralateral clavicle and shoulder and then down the arm to the wrist. In the secondary cycle, known as the ‘secondary treatment cycle’, the functional joint manipulations, each applied on one treatment session sequentially begins on the non-dominate leg and continues upward to the contralateral clavicle and shoulder and down the contralateral arm to the wrist. After the ‘secondary treatment cycle’ is completed, a tertiary cycle that is identical to the ‘primary treatment cycle’ is followed.

At least one overnight sleep period should occur between each functional joint manipulation for optimal therapeutic effect. One functional joint manipulation is performed in each treatment session, therefore the entire three treatment cycles are completed in 27 treatment sessions.

### DESCRIPTION OF THE DRAWINGS

FIG. 1 illustrates a partial skeletal structure of a patient being treated with the method described herein with the following treatment sequence locations identified: Sequence 1 (dominant-side foot); Sequence 2 (dominant-side knee), Sequence 3 (dominant-side hip); and Sequence 4 (dominant-side pubic symphysis).

FIG. 2 illustrates a partial skeletal structure of a patient being treated with methods of the present invention, showing Sequence 5 (dominant-side sacrotuberous ligament).

FIG. 3 illustrates a partial skeletal structure of a patient being treated with methods of the present invention, with the following treatment sequence locations identified: Sequence 6 (contralateral proximal clavicle); Sequence 7 (contralateral shoulder); Sequence 8 (contralateral elbow); and Sequence 9 (contralateral wrist).

FIG. 4 illustrates a partial skeletal structure of a patient being treated with methods of the present invention, with the following treatment sequence locations identified: Sequence 10 (non-dominant-side foot); Sequence 11 (non-dominant-side knee); Sequence 12 (non-dominant-side hip); and Sequence 13 (non-dominant side pubic symphysis).

FIG. 5 illustrates a partial skeletal structure of a patient being treated with the methods of the present invention, showing Sequence 14 (Non-Dominant-side sacrotuberous ligament).

FIG. 6 illustrates a partial skeletal structure of a patient being treated with methods of the present invention, with the following treatment sequence locations identified: Sequence 15 (contralateral proximal clavicle); Sequence 16 (contralateral shoulder); Sequence 17 (contralateral elbow); and Sequence 18 (contralateral wrist).

FIG. 7 illustrates a partial skeletal structure of a patient being treated with the method described herein with the following treatment sequence locations identified: Sequence 19 (dominant-side foot); Sequence 20 (dominant-side knee); Sequence 21 (dominant-side hip); and Sequence 22 (dominant-side pubic symphysis).

FIG. 8 illustrates a partial skeletal structure of a patient being treated with methods of the present invention, with the dominant side sacrotuberous ligament being identified as Sequence 23.

FIG. 9 illustrates a partial skeletal structure of a patient being treated with methods of the present invention, with the following treatment sequence locations identified: Sequence 24 (contralateral proximal clavicle); Sequence 25 (contralateral shoulder); Sequence 26 (contralateral elbow); and Sequence 27 (contralateral wrist).

FIG. 10 is a photograph showing a practitioner manipulating the ankle mortise joint pulling the ankle in a dorsal to plantar direction.

FIG. 11 is a photograph showing a practitioner manipulating the first ray complex pulling the proximal base of first metatarsal in a dorsal to plantar direction.

FIG. 12 is a photograph showing a practitioner manipulating the subtalar joint pulling the calcaneus in a dorsal to plantar direction.

FIG. 13 is a photograph showing a practitioner manipulating the subtalar joint pushing the medial calcaneus in a medial to lateral direction.

FIG. 14 is a photograph showing a practitioner manipulating the subtalar joint with a lift and drop of the calcaneus on a toggle board medial to lateral; on impact, the calcaneus moves in a lateral to medial direction.

FIG. 15 is a photograph showing a practitioner manipulating the talus joint pushing the medial talus in a medial to lateral direction.

FIG. 16 is a photograph showing a practitioner manipulating the subtalus joint pushing the medial calcaneus and lateral talus in a lateral to medial direction.

FIG. 17 is a photograph showing a practitioner manipulating the calcaneus joint pushing the posterior calcaneus on the talus in a posterior to anterior direction.

FIG. 18 is an illustration showing a practitioner manipulating the transtarsal joint pushing the transtarsal joint in a dorsal to plantar direction

FIG. 19 is an illustration showing a practitioner manipulating the ankle mortise joint pushing the ankle mortise joint in an anterior to posterior direction with distal tibia internal rotation.

FIG. 20 is an illustration showing a practitioner manipulating the calcaneocuboid joint pushing the dorsolateral cuboid in a dorsal to plantar direction.

FIG. 21 is an illustration showing a practitioner manipulating the calcaneocuboid joint pushing the plantar-lateral cuboid in a plantar to dorsal direction.

FIG. 22 is an illustration showing a practitioner manipulating the calcaneocuboid joint pushing the lateral cuboid in a lateral to medial direction.

FIG. 23 is a photograph showing a practitioner manipulating the talocalcaneonavicular joint pushing the talocalcaneonavicular joint in a dorsal to plantar direction.

FIG. 24 is a photograph showing a practitioner manipulating the first cuneonavicular joint pushing the first cuneonavicular joint in a dorsal to plantar direction.

FIG. 25 is a photograph showing a practitioner manipulating the first ray complex pulling the proximal base of first metatarsal in a dorsal to plantar, lateral to medial direction.

FIG. 26 is a photograph showing a practitioner manipulating the talocalcaneonavicular joint pulling the talocalcaneonavicular joint in a plantar to dorsal, medial to lateral direction.

FIG. 27 is a photograph showing a practitioner manipulating the first cuneonavicular joint pulling the first cuneonavicular joint in a plantar to dorsal, medial to lateral direction.

FIG. 28 is a photograph showing a practitioner manipulating the first ray complex pulling the first ray complex in a plantar to dorsal, medial to lateral direction.

FIG. 29 is a photograph showing a practitioner manipulating the tibia on the femur pushing the proximal tibia on the distal femur in a lateral to medial direction.

FIG. 30 is a photograph showing a practitioner manipulating the tibia on femur pushing the proximal tibia on the distal femur with external rotation in an anterior to posterior direction.

FIG. 31 is a photograph showing a practitioner manipulating the tibia on femur pulling the proximal tibia on the distal femur in a posterior to anterior direction.

FIG. 32 is a photograph showing a practitioner manipulating the tibia-fibula joint pushing the fibula on the tibia with internal to external rotation in an anterior to posterior direction.

FIG. 33 is a photograph showing a practitioner manipulating the tibia-fibula joint pulling the fibula on the tibia with external to internal rotation in a posterior to anterior direction.

FIG. 34 is a photograph showing a practitioner manipulating the femuroacetabular joint with circumduction of the femoral head in the acetabulum in a lateral to medial, anterior to posterior direction.

FIG. 35 is a photograph showing a practitioner manipulating the pubic symphysis pushing the pubic ramus in a superior to inferior direction.

FIG. 36 is a photograph showing a practitioner treating the sacrotuberous ligament pushing on the medial sacrotuberous ligament in a medial to lateral and posterior to anterior direction.

FIG. 37 is an illustration showing a practitioner manipulating the clavicle pushing the proximal clavicle in a medial to lateral and anterior to posterior direction.

FIG. 38 is an illustration showing a practitioner manipulating the proximal humerus pulling the humerus in the glenoid fossa with internal rotation, medial to lateral in an anterior to posterior direction.

FIG. 39 is an illustration showing a practitioner manipulating the proximal humerus pulling the humerus in the glenoid fossa with external rotation, medial to lateral in an anterior to posterior direction.

FIG. 40 is an illustration showing a practitioner manipulating the acromioclavicular joint pushing on the posterior acromioclavicular joint with internal rotation of distal clavicle on acromion process in a posterior to anterior direction with external rotation of the humerus.

FIG. 41 is an illustration showing a practitioner manipulating the elbow pushing the proximal radius in the ulnar notch with external to internal rotation in a posterior to anterior direction.

FIG. 42 is a photograph showing a practitioner manipulating the elbow pushing the proximal ulna on distal humerus in a posterior to anterior direction.

FIG. 43 is a photograph showing a practitioner manipulating the elbow pushing the proximal posterolateral radius and ulna to a medial to lateral/lateral to medial direction.

FIG. 44 is a photograph showing a practitioner manipulating the wrist pushing the posterior distal radius on proximal carpals in a posterior to anterior direction.

FIG. 45 is a photograph showing a practitioner manipulating the wrist pushing the posterior distal ulna on fibrocartilage in a posterior to anterior direction.

FIG. 46 is a photograph showing a practitioner manipulating the wrist pushing the posterior distal radioulnar joint in a posterior to anterior direction.

FIG. 47 is a photograph showing a practitioner manipulating the wrist pushing the proximal and distal carpals in a posterior to anterior, anterior to posterior direction.

### DESCRIPTION OF THE PREFERRED EMBODIMENT(S)

Embodiments of the present invention involve application of physical adjustments to a patient's body using manual application of force, or through manipulation with assistance using mechanical equipment. Some alternative embodiments of the present invention may utilize such instruments as an activator instrument, a toggle board, and a chiropractic table, all of which are described below.

A conventional activator instrument that may be used under the present invention is a prior-art type used in the chiropractic disciplines, and has features similar to a combination syringe and a pogo stick. The length of the activator used in embodiments of the present invention has a length of about 20 cm, although different sized activators may be used as the situation requires. The activator has a hard rubber foot with a diameter of about a centimeter with an adjustable spring tensioner which presets the applied force. When pushed down, the activator delivers a small controlled mechanical “punch” to the specific area it is in contact with restoring motion to a restricted joint.

Another conventional instrument used in various embodiments of the present invention is what is known as a toggle board. The Thule toggle board is one particular type used in preferred embodiments herein. The Thule toggle board was originally designed for chiropractic treatment of the top vertebra in the cervical spine. It can also be used for the treatment of extremities for the correction of biomechanical joint dysfunctions. The toggle board comprises two sections, upper and lower. In one version used in aspects of the present invention, each section measures approximately 8 inches in length, 5.5 inches in width, and 1 inch in height. The upper section is connected to the lower section at one end by a 5 inch by 0.75 inch steel bracket which attaches to the outside borders of the lower section of the toggle board. The upper section is a one-half inch cushion surface over a one-half inch solid wood foundation. This section is upholstered with a vinyl-type material. The underside of the upper section has a 2.5 inch by 2 inch hard plastic square which is secured by four perimeter bolts. The lower portion of the toggle board is solid wood, such as oak. Five inches from the end of this board there is a 3 inch aluminum lever on the lateral surface of this board which when lifted raises a hard plastic peg located on the top side of this solid wood board. This peg lifts approximately 0.5 inches which presses against the opposing hard plastic 2.5 inch by 2 inch located on the underside of the vinyl upholstered piece. The raising of this lever arm raises the upper upholstered piece slightly over 0.5 inches at the opened end.

On the opposite lateral side of the board there is a 0.75 inch diameter circular flat knob which can be turned to adjust the amount of tension on the peg, which allows the board to adapt to heavier or lighter extremity weight. If for example we are adjusting a joint within the foot, the foot is placed on the vinyl padded upper section of the board. The practitioner then applies a downward force, causing the hard plastic peg to release, causing the upper section to drop on to the lower section. The momentum of the upper section falling with the extremity weight striking the stationary lower section causes a slight jarring of the joint, restoring the desired motion to the restricted joint.

A chiropractic table is used in various embodiments of the present invention. In a preferred embodiment, the chiropractic table is a conventional table such as the Hill Air Drop HA90C. The specifications for the preferred chiropractic table are as follows: electrically controlled height 21.5 to 30.5 inches; tilting headpiece—30° negative and positive tilt; Air-Dual drop forward and straight-motion headpiece; Air-Thoracic breakaway; Air-Thoracic drop; Air-Lumbar drop; Air-Pelvic drop; Rocker foot pedal to raise or lower the table height; Air-powered foot control from foot end; Standard width—24 inches; Length—6 feet 3 inches; Foam top—2.5 inches; Arm rests, 13 inch face cut-out; and paper roll. The table is used with the patient either prone, supine or side lying, as specified herein. With various aspects of the present invention, adjustments are performed to areas of joint dysfunction in the extremities using the drop pieces mentioned above. In the preferred chiropractic table, these air drop pieces are supplied by a large air-storage tank and mini-compressor which are enclosed within the table's base skirting. A compressor runs periodically to replenish the air tank.

The preferred chiropractic table uses an Air-Breakaway controlled by a foot pedal. The pedal increases or decreases the air-spring pressure in the thoracic and lumbar sections providing a controlled recoil action. The table has electrically adjustable height. Height adjustment is actuated by a rocker foot pedal that is mounted to the base and can be accessed from either side of the table.

As noted with the toggle board, when the table piece drops there is a slight jarring of the joint, restoring the desired motion to the restricted joint. A directed manual “push” using mostly the patient's own body weight, is needed to activate the chiropractic table and toggle board drop piece mechanisms.

In alternative embodiments of the present invention, one diagnostic method used to determine the presence of joint dysfunction is called motion palpation. With motion palpation, the doctor sits behind the seated patient to examine the spine. The doctor's left hand is commonly placed on the patient's left shoulder. The doctor's right hand is used by pressing with the flat of the first on the spinal segments, pushing forward slightly at each level while checking for joint play or spring between each vertebra. The normal actions of flexion, extension, left and right lateral flexion and rotation can be evaluated with this method. The joints of the pelvis, arms and legs also can be accurately palpated for motion. Through motion palpation diagnosis, it can be determined at what segments joint dysfunction is present and when and where corrective adjustments are needed. Once treatment is administered, the affected area is re-palpated to see if normal joint function has been restored.

The practitioner may also determine which leg is the body-dominant leg by having the patient lie supine, with both legs initially straight. The practitioner alternatively brings each leg, one at a time to the patient's chest, and through motion palpation determines which leg requires more force to bend to the chest and/or has less range of motion, and that leg is established as the dominant leg. Those of skill in the relevant arts also recognize that other techniques may be used to determine the dominant leg. For most of the population, the right leg has been found to be the dominant leg.

### Treatment by Patterns of Adjustments in Sequentially-Ordered Steps

There is provided a system and method for treating a patient by administering a predetermined treatment sequence of restorative joint adjustments to a patient's body.

The study of the human gait cycle shows that beginning with heel strike, feet adapt to the ground surface walked upon, and likewise, the feet absorb the shock of each step. This absorbing of shock slows down the ground reactive force so the surrounding tissues of the leg can further dampen it. The result is reduced stress on the musculoskeletal system.

The absorption of force depends on proper joint function throughout the foot and ankle. These joints must move within their ranges to efficiently absorb shock. Unfortunately, the average foot and ankle joints do not move within their ranges, since they experience an abundance of joint dysfunction.

This joint dysfunction is caused by modern-day walking surfaces. Before paved walkways and solid flooring were commonplace, humans used to walk on irregular surfaces such as dirt, sand, moss, rocks, and tree roots. The normal deformation of the feet when traversing these uneven surfaces promoted more flexibility in the joints of the foot and ankle while walking. Natural surfaces were often more cushioned, which further reduced the stress coupled to the human body from walking.

Hard surfaces, such as, concrete, asphalt, hardwood, tile and marble, are less forgiving and more rigid. These flat, hard surfaces do not promote joint flexibility, rather they promote joint dysfunction. Without proper joint function the foot and ankle cannot efficiently absorb and dissipate ground reactive forces. This leads to pathological amounts of stress repeatedly travelling throughout the musculoskeletal system. Further, to stabilize itself, the spine tightens muscles and compresses joints to adapt to this continuous force. The result is a degenerating spine that lacks function and mobility, creating an environment for injury.

Joints in the sacroiliac region react to oncoming force by compression of the sacrum on the ileum. This takes place through surrounding muscle contractions compressing the sacroiliac joint together, as the body “braces” for impact. Studies suggest that the body attempts to compress the joints together to enhance stability.

Underlying theories of the present invention are similarly founded on these principles: modern-day humans are surrounded by an abundance of flat, hard, and mostly horizontal walking surfaces. Walking and running in this environment cause joints in the feet and ankles to become dysfunctional. Humans no longer absorb the shock from ground reactive forces efficiently. Every day, just from walking and related activities, approximately 700 tons of unimpeded force travel up legs, into the pelvis and spine. To brace itself from repetitive heel strikes and the generated force, the human body compresses joints together throughout the musculoskeletal structure to provide stability. This compression of joints involves the feet, ankles, knees, hips, pelvis, spine, shoulders, elbows and wrists.

In the present model of chiropractic, a practitioner will examine a new patient's spine and determine multiple joint dysfunctions, or subluxations. Random adjustments will be administered to the patient's spine based on a specific or combination of chiropractic techniques the particular doctor practices. The patient will leave the clinic and return to the surrounding “hardscape” which promotes further bracing and joint compression. With little surprise, the patient returns for treatment with the same joint dysfunction as before. The traditional reasoning of the chiropractic profession is repetitive, long term treatment is necessary to correct a condition long standing.

Methods and systems of the present invention address the underlying issues that arise from the patient's traversal of surrounding “hardscape” surfaces. In one embodiment, joint dysfunctions within the gait cycle can be corrected to allow for more efficient transfer of forces, less bracing, and reduced joint compressions. When normal motion is restored to the foot, the improved strike force handling of body structures allows the spine to flex and operate normally again, restoring normal nerve supply and joint function throughout the body.

Methods of the present invention were developed to restore normal function by applying certain treatments in a specific order. The developed methods and systems of the present invention will allow the patient's body to respond favorably to a “pattern” of functional joint manipulations with an automatic correction of joint dysfunction. In a preferred embodiment, three treatment cycles are used each comprising nine functional joint manipulations each applied in one treatment session sequentially by the practitioner that follows the natural shockwave that propagates from the striding foot impacting the ground and travels up the leg through the pelvis and to the opposite clavicle, down the opposite arm and to the opposite wrist. An individual usually uses the dominate leg to initiate a stride.

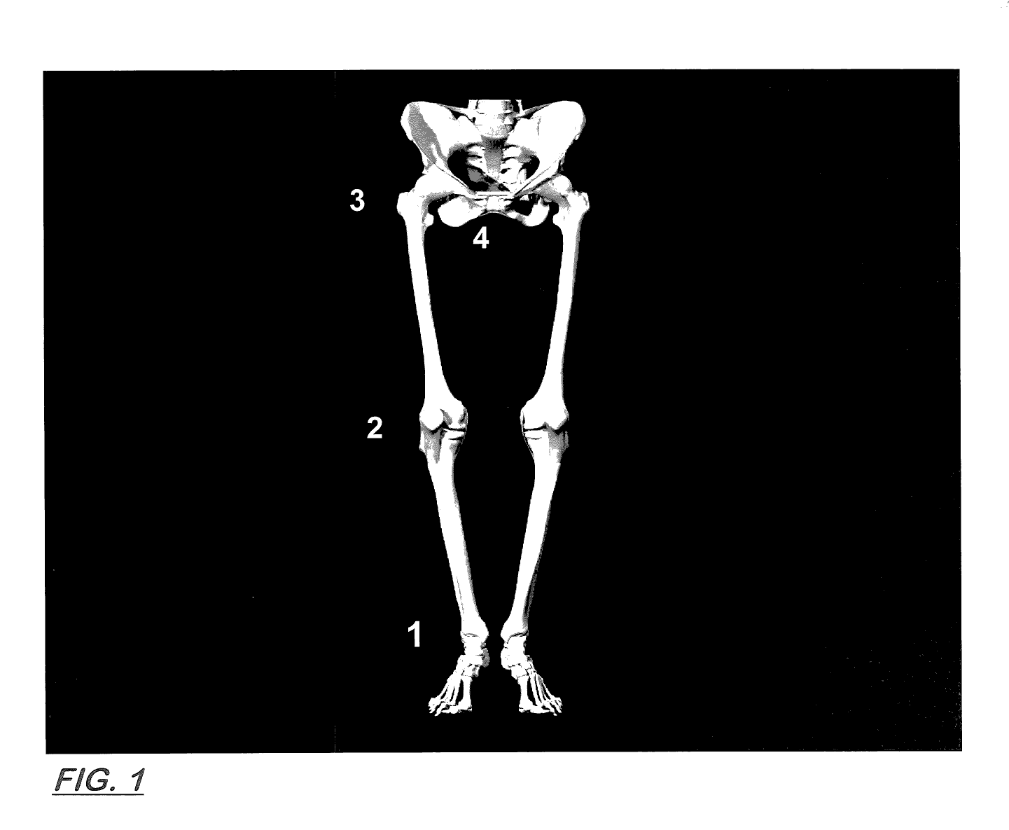

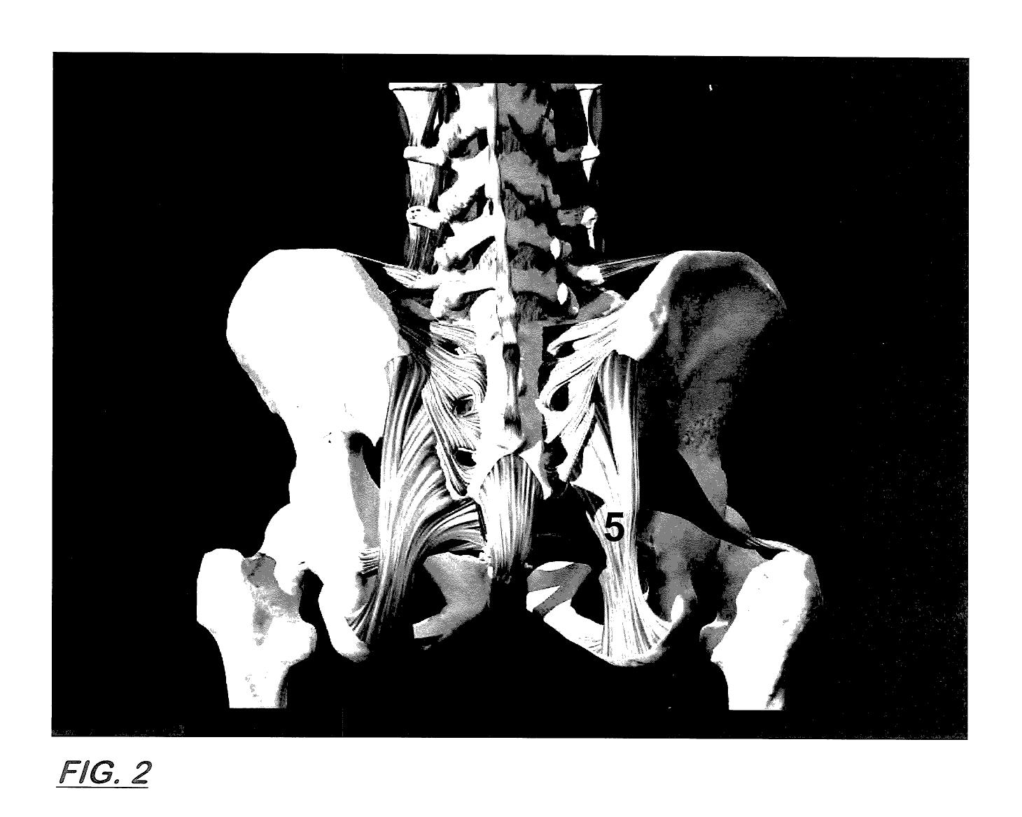

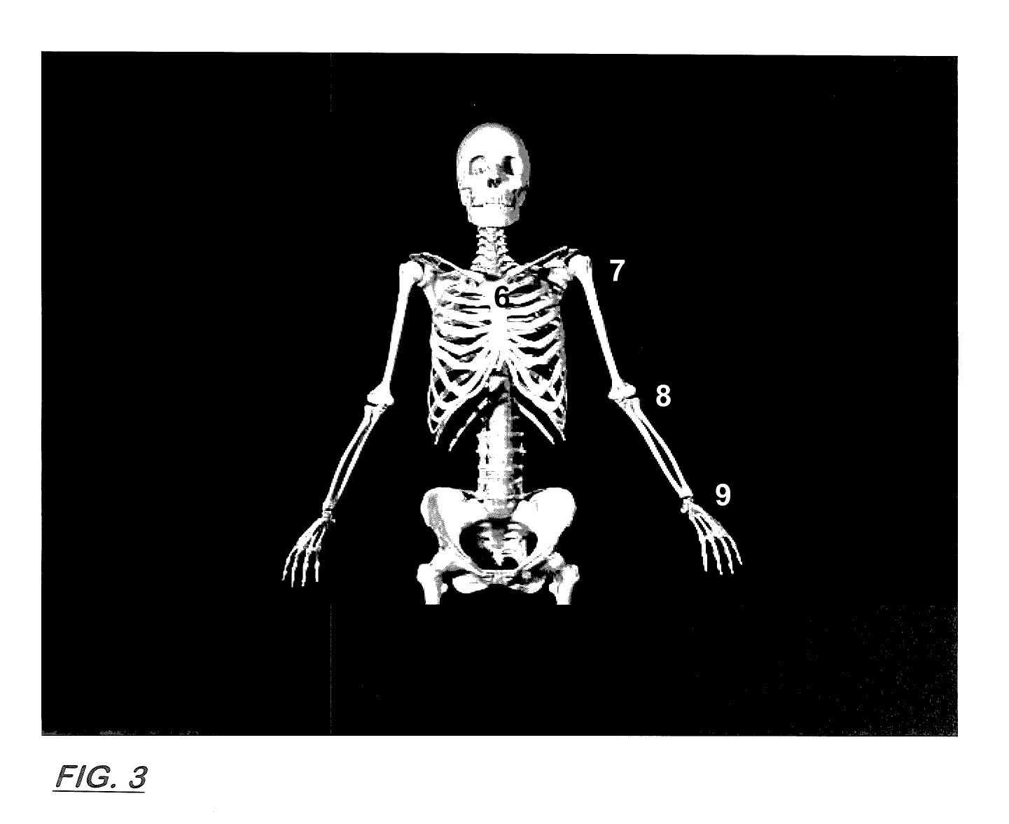

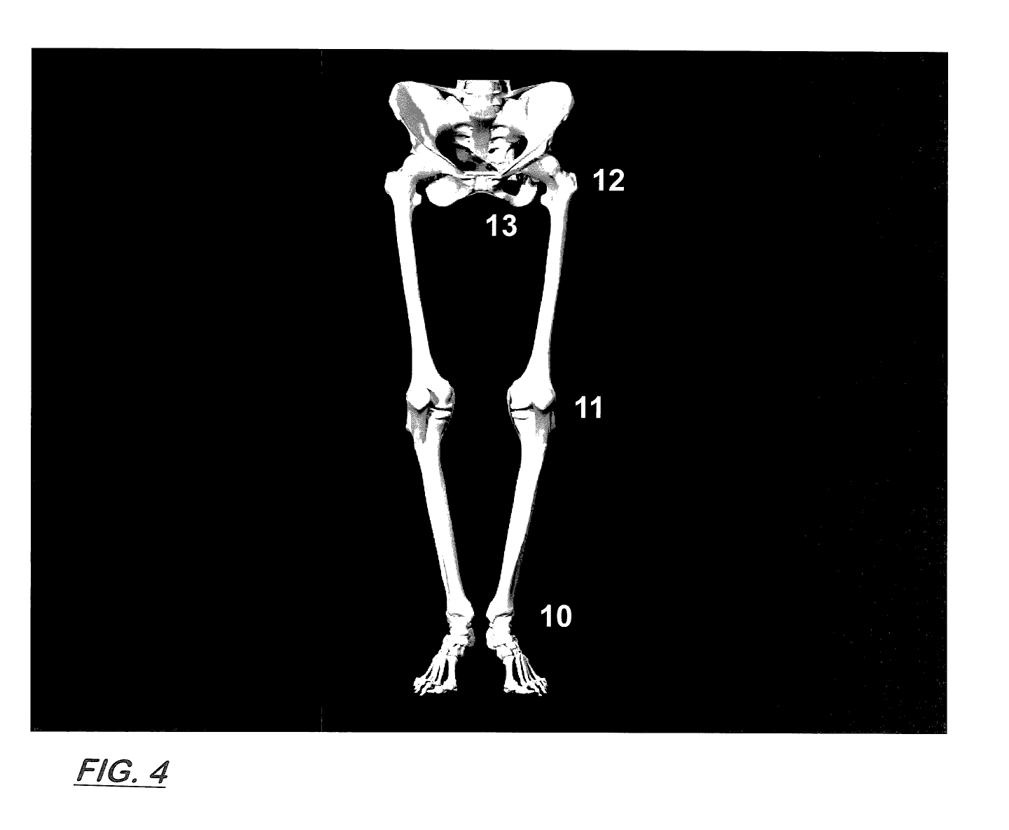

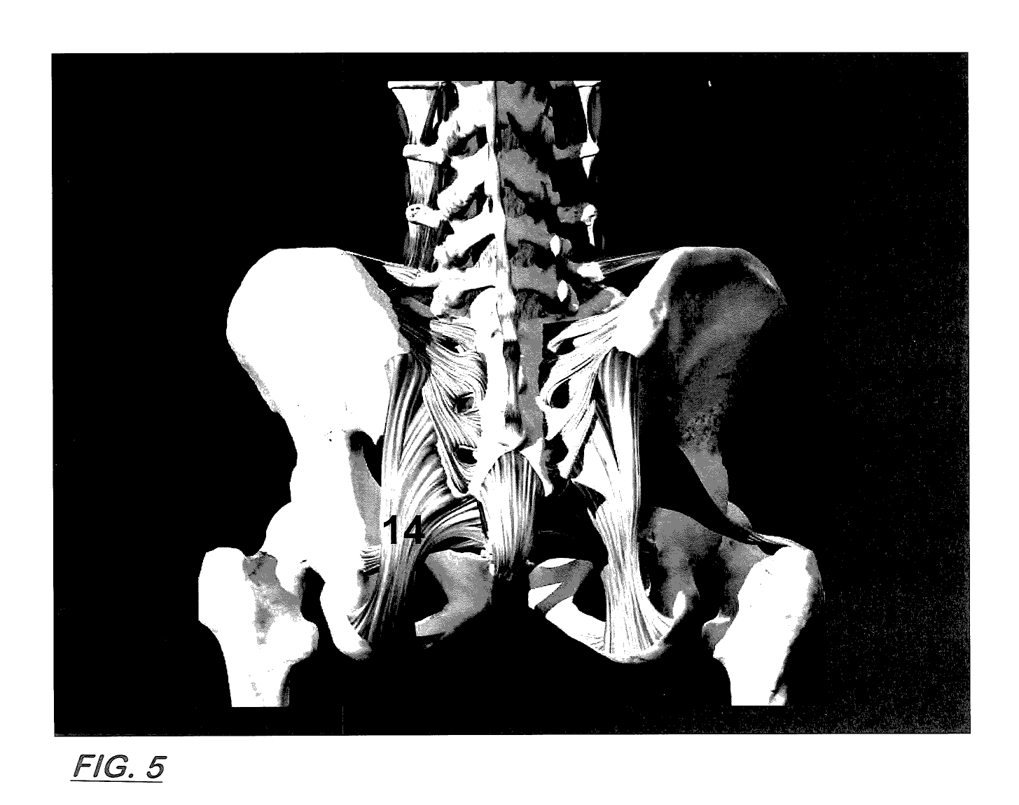

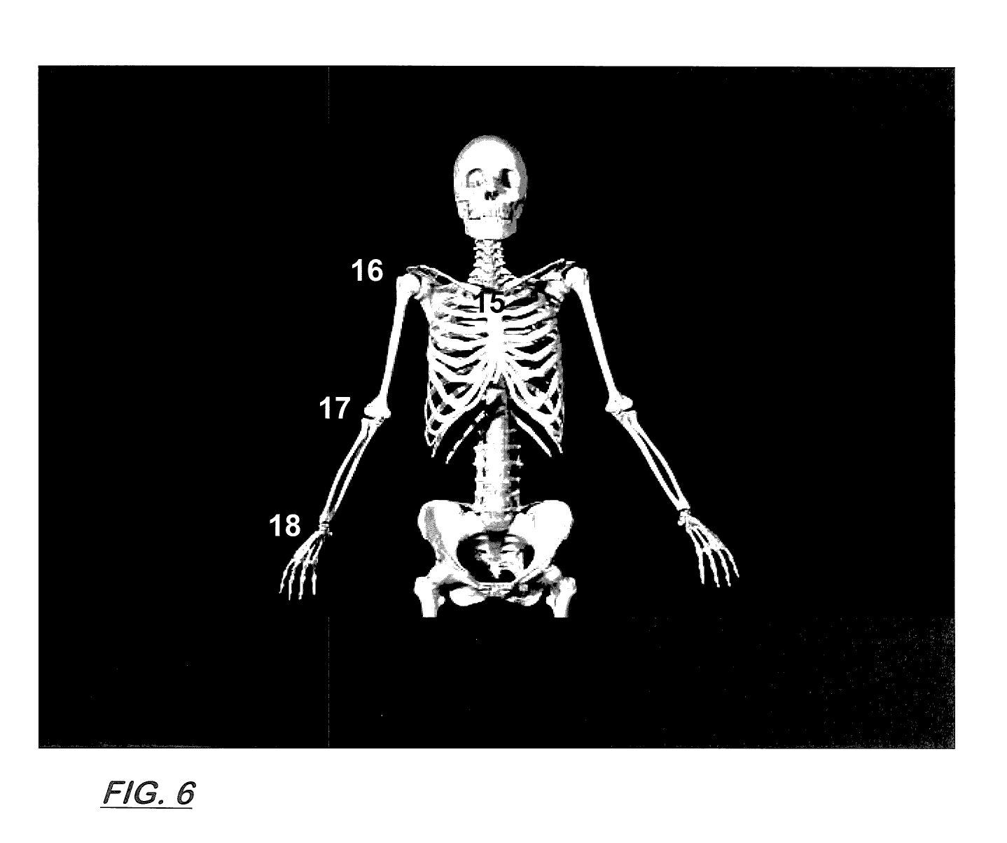

The first cycle, known as a ‘primary treatment cycle’, comprises nine functional joint manipulations shown in FIGS. 1-3 beginning on the patient's dominate leg and moves upward on the dominate leg and then contralateral to the clavicle and shoulder and then down the aim to the wrist. In the secondary cycle, known as the ‘secondary treatment cycle’ shown in FIGS. 4-6, the functional joint manipulations each applied on separate treatment sessions sequentially beginning on the non-dominate leg and continue upward to the contralateral clavicle and shoulder and down the contralateral arm to the wrist.

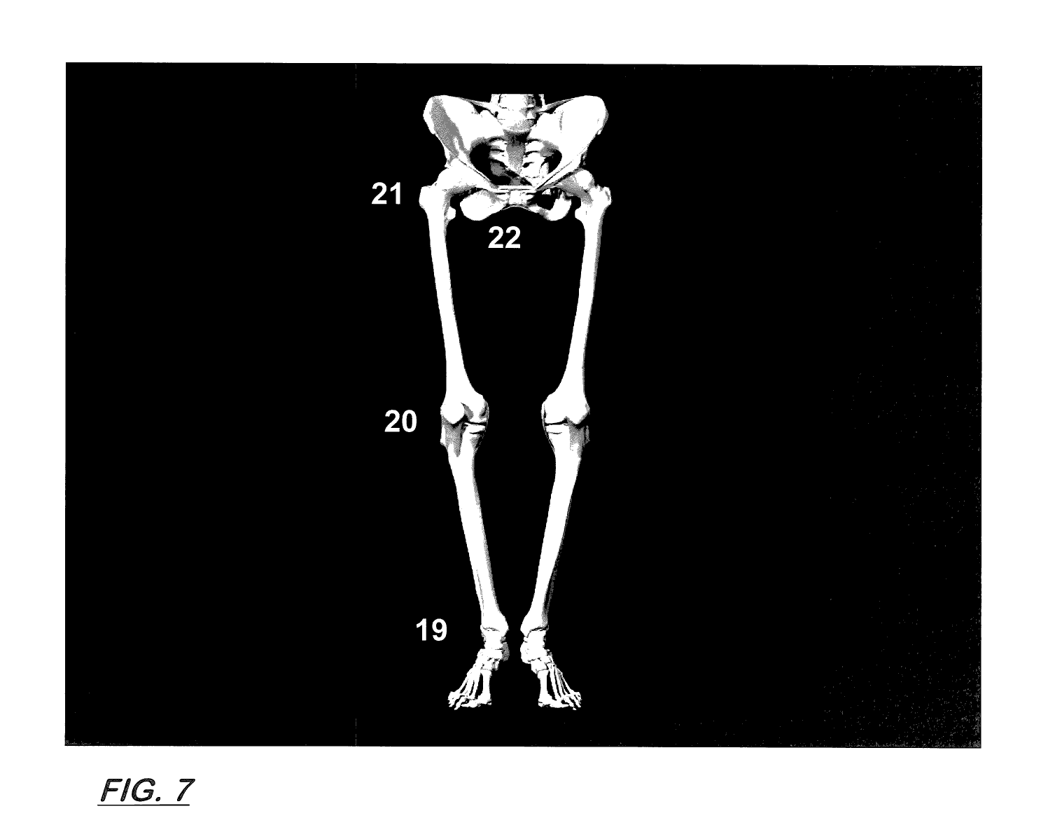

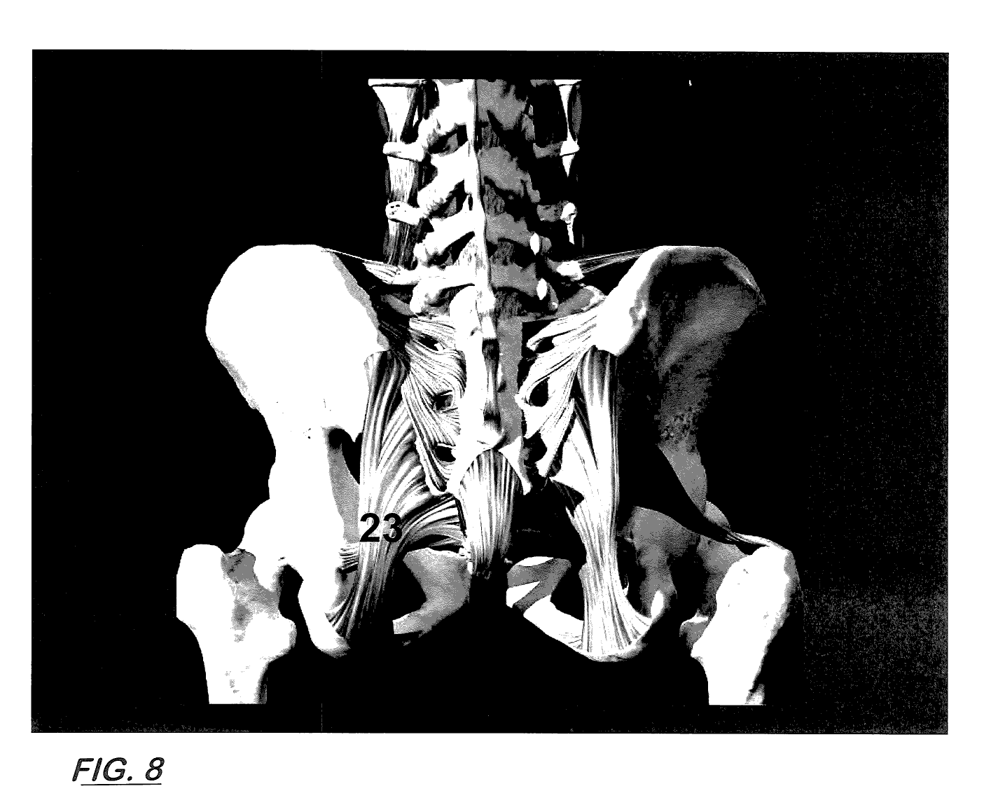

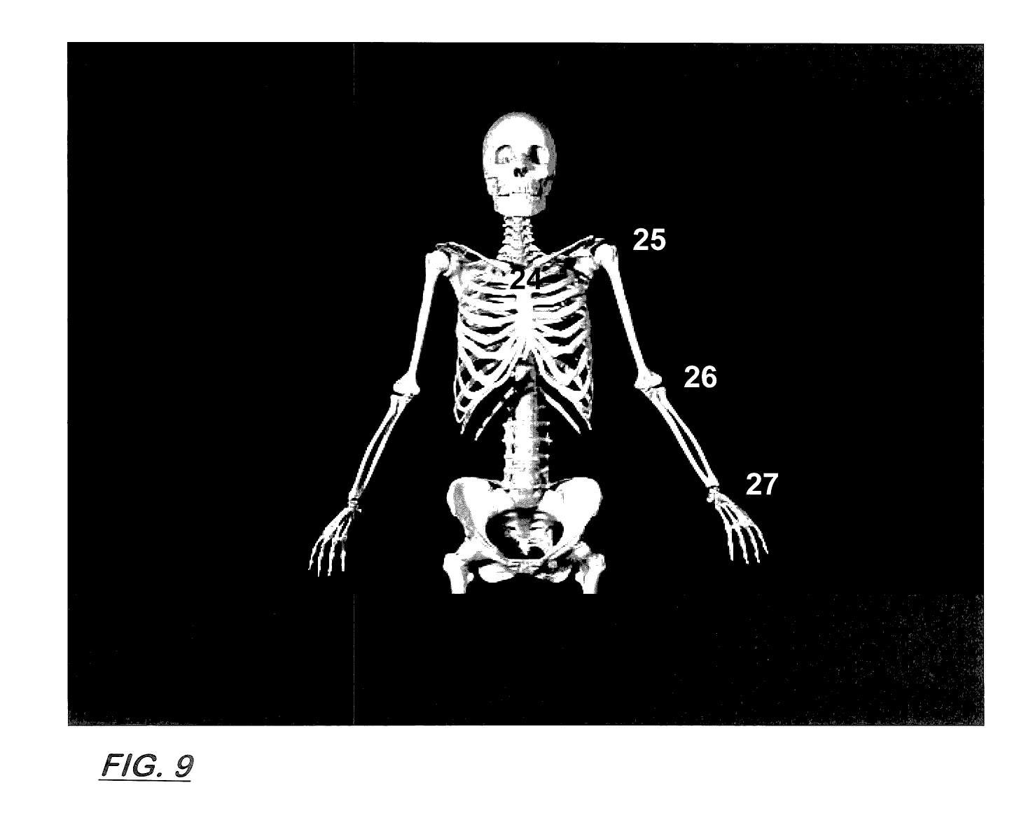

After the secondary treatment cycle’ is completed, a tertiary cycle that is identical to the ‘primary treatment cycle’ is followed shown in FIGS. 7-9.

At least one overnight sleep period should occur between each functional joint manipulation for optimal therapeutic effect. One functional joint manipulation is performed each treatment session, therefore the entire three treatment cycles are completed in 27 treatment sessions.

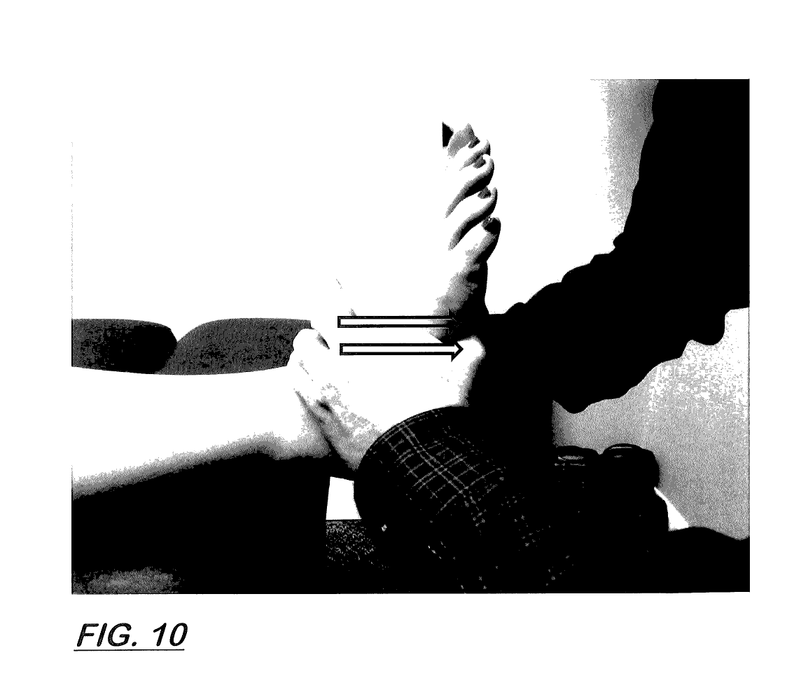

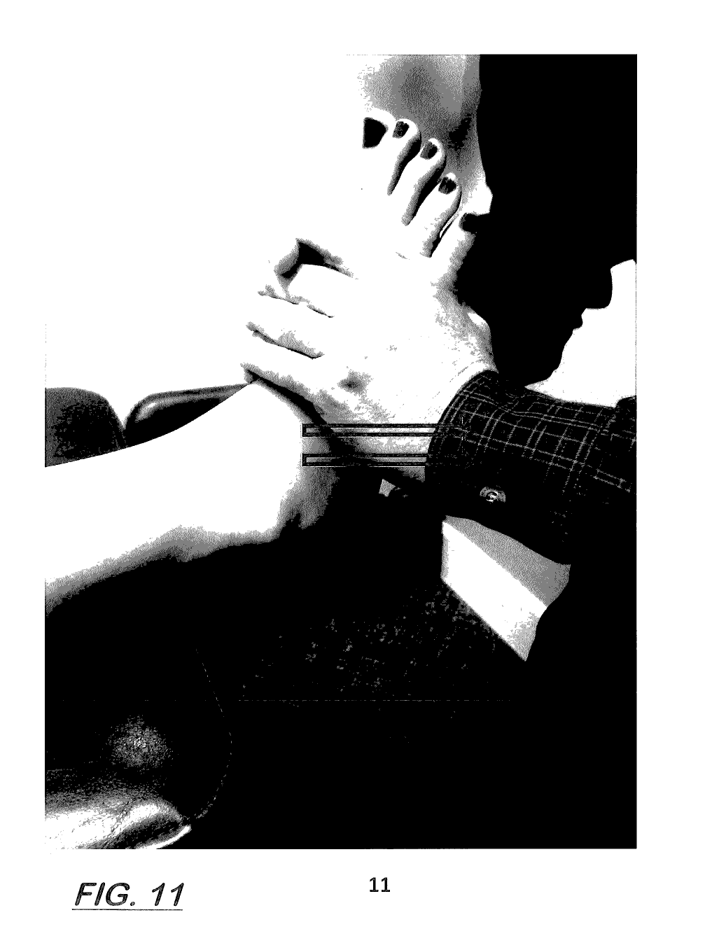

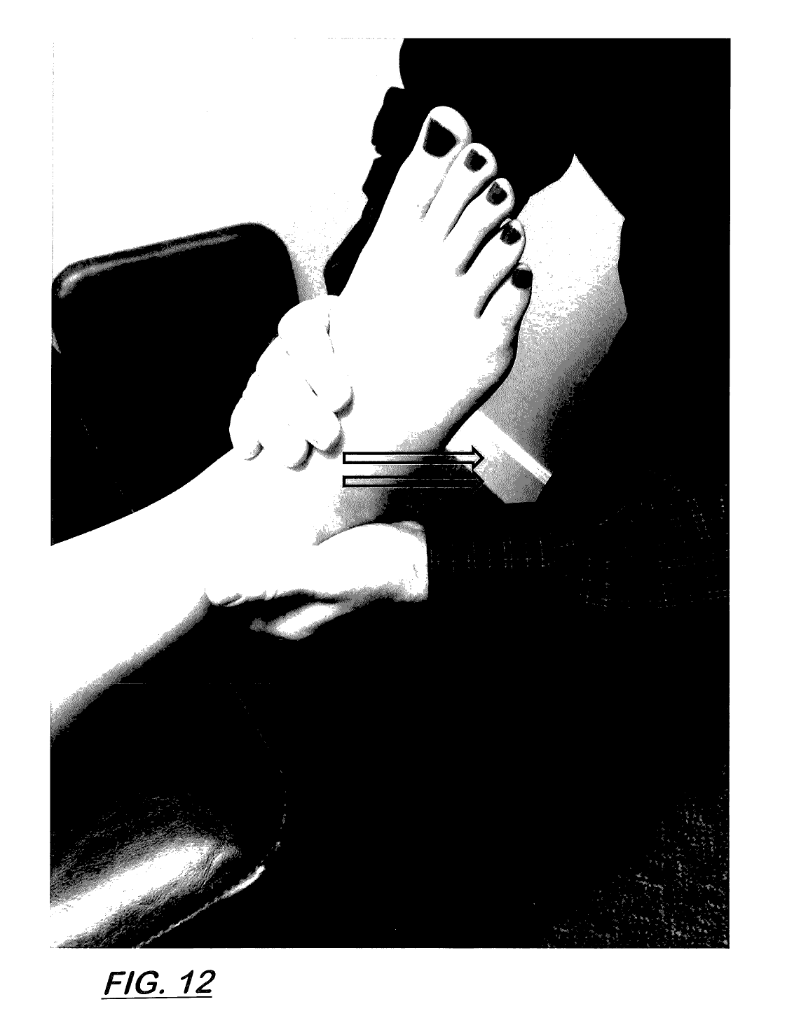

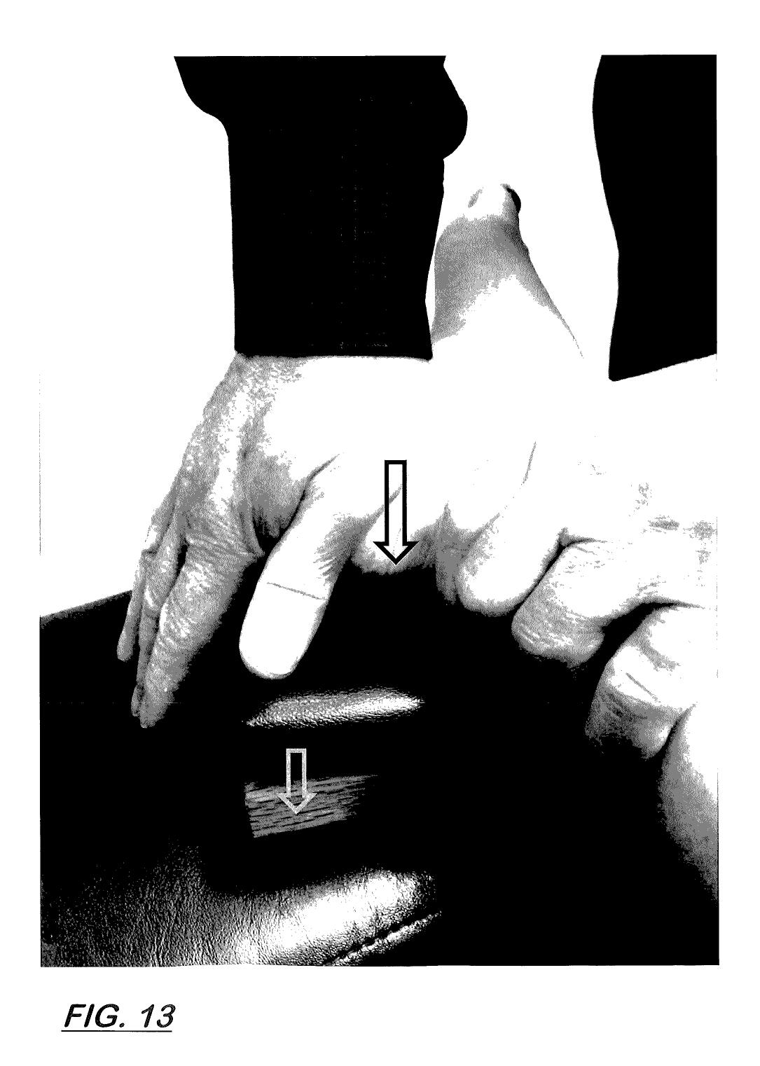

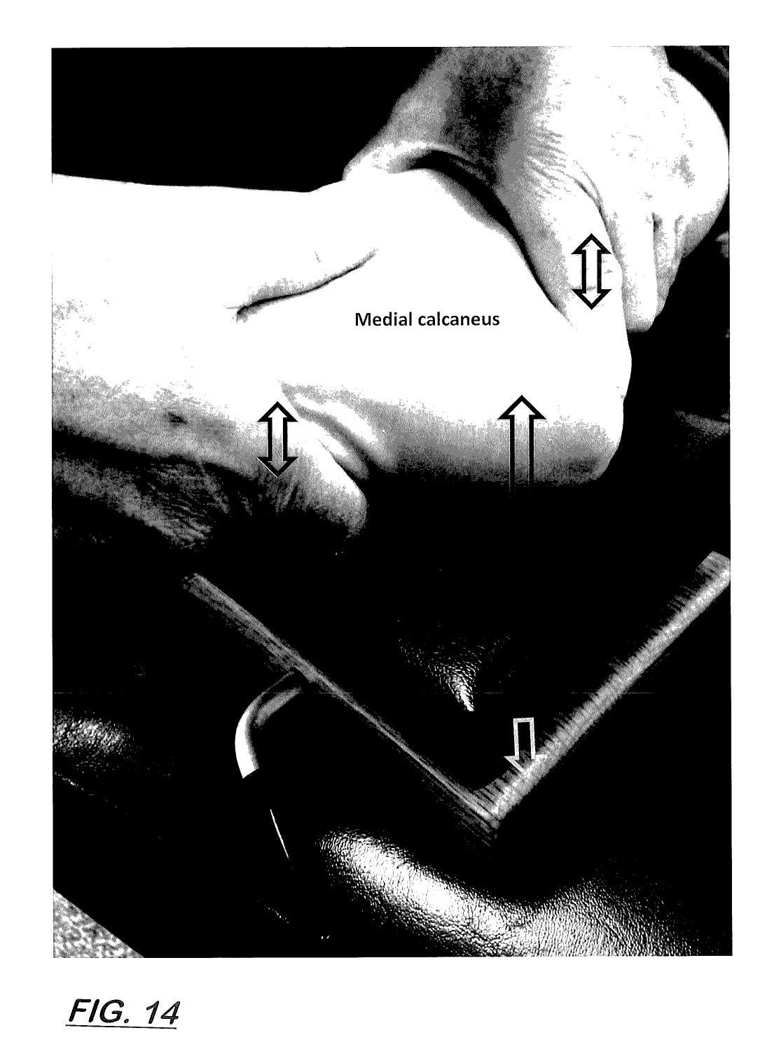

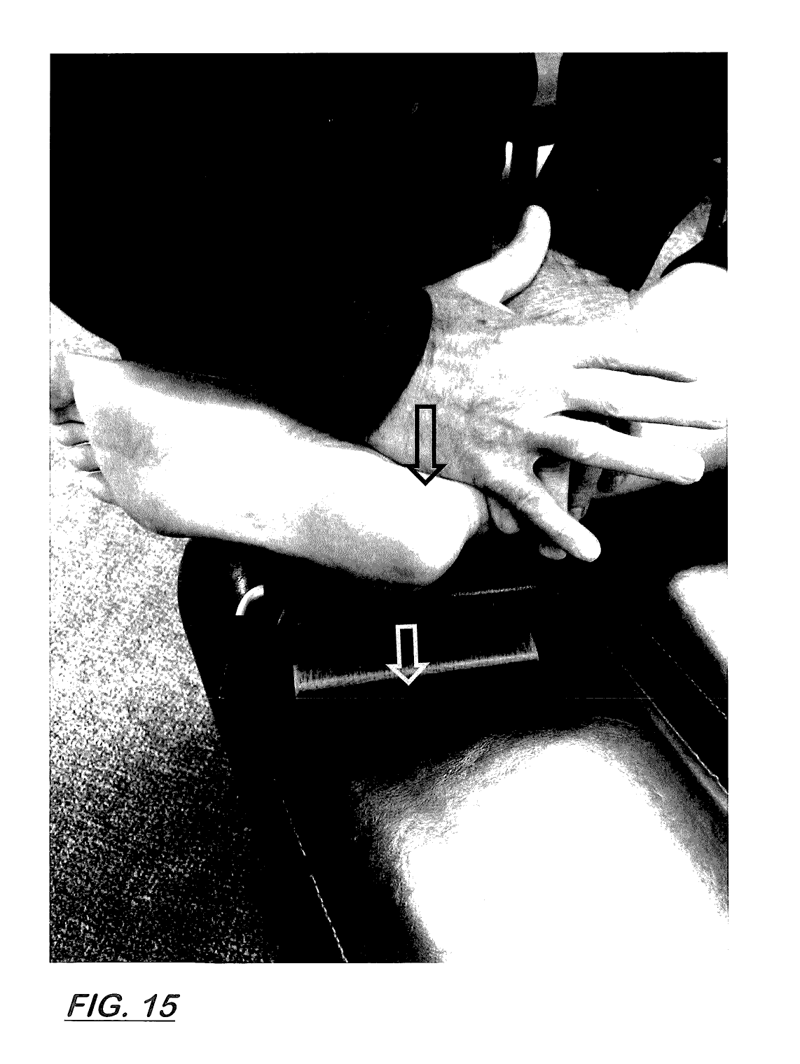

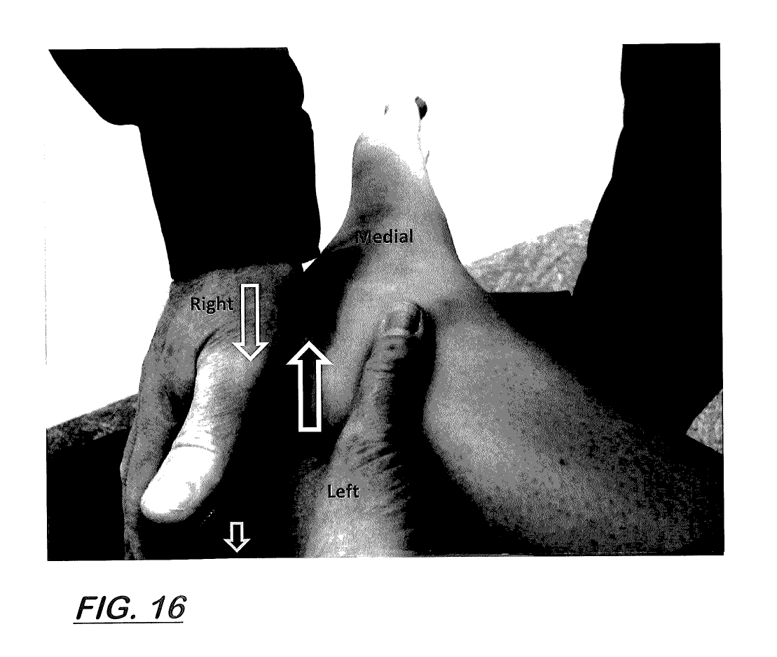

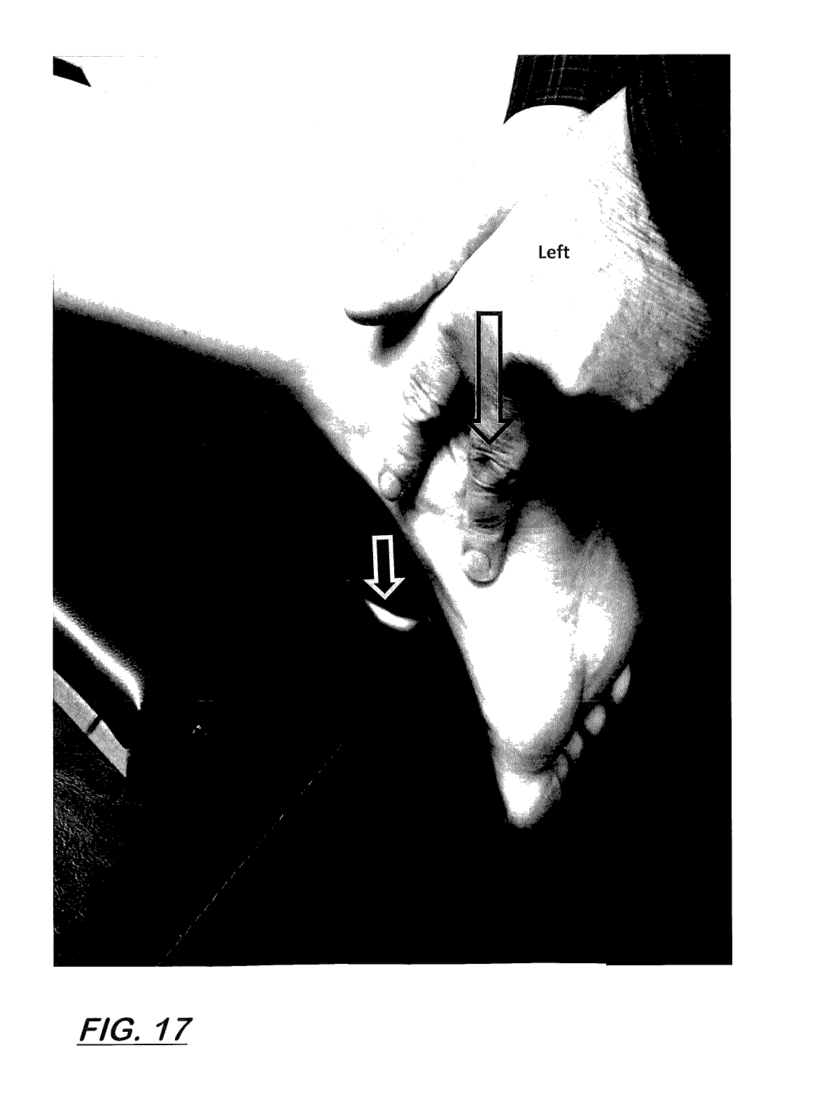

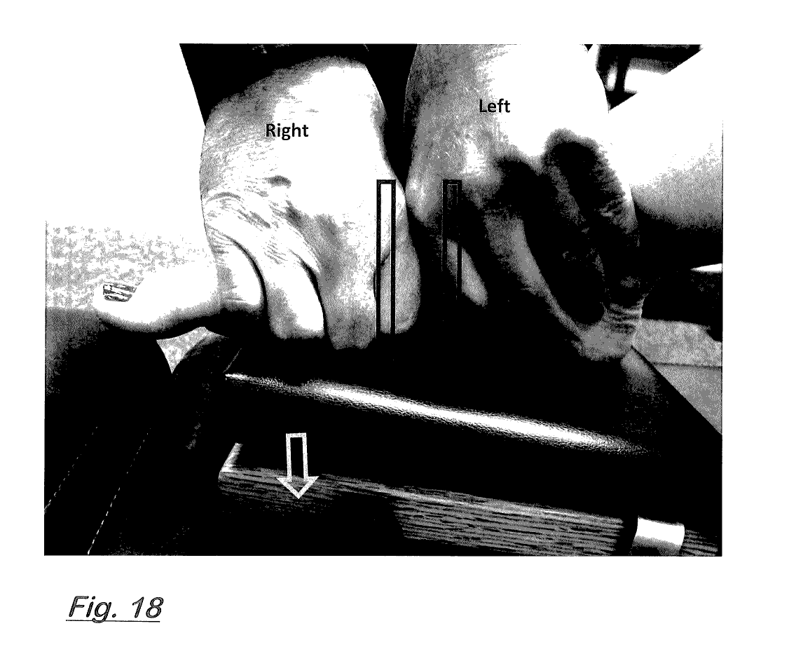

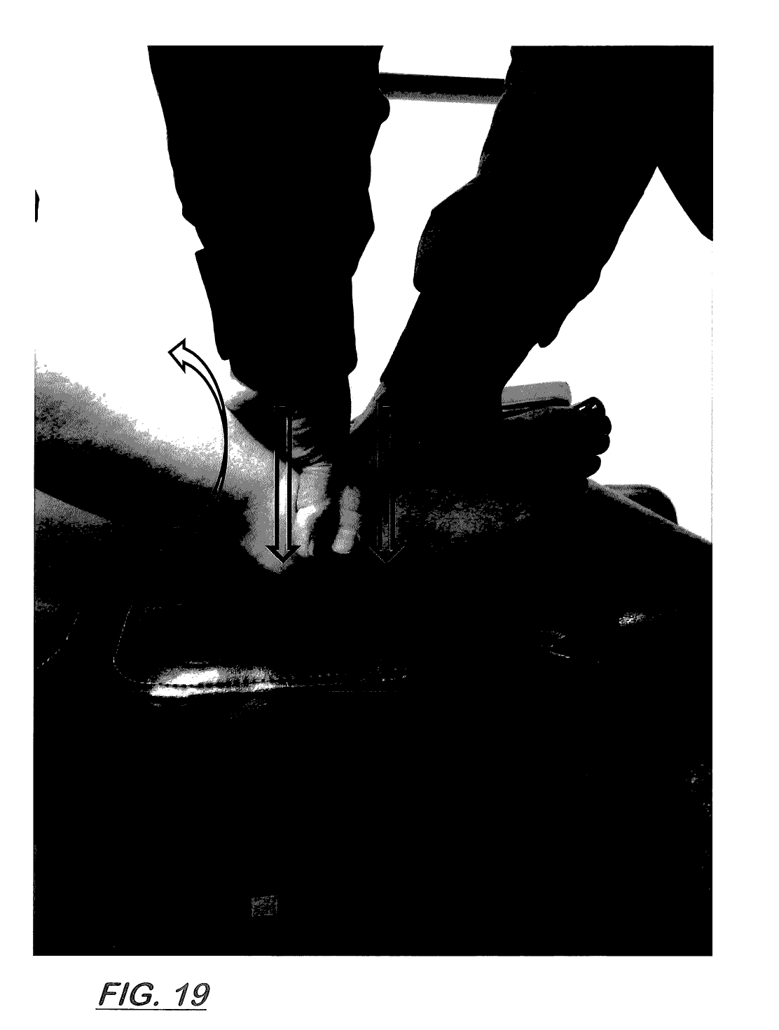

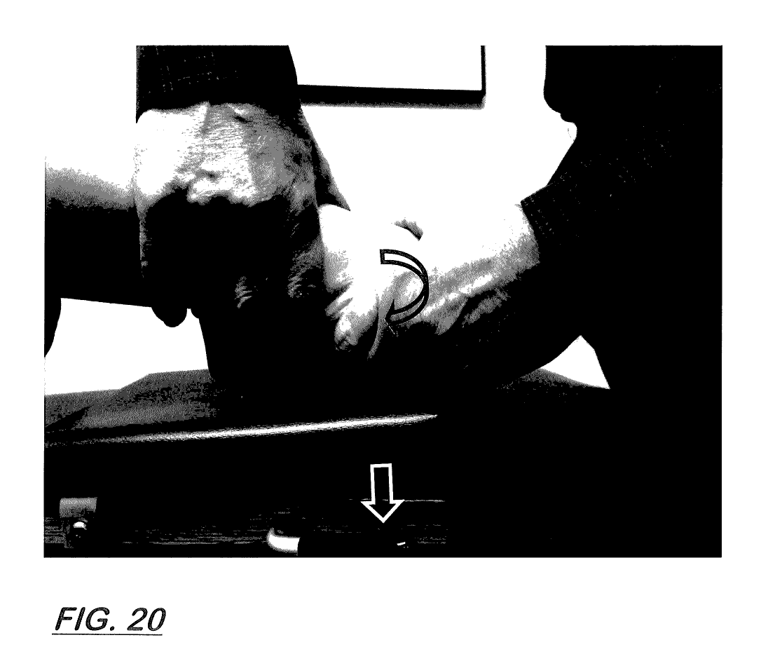

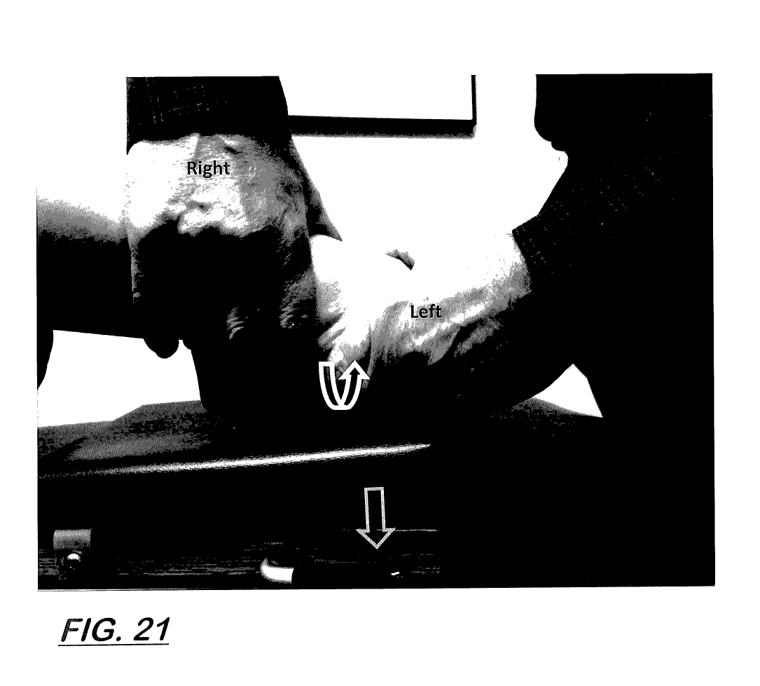

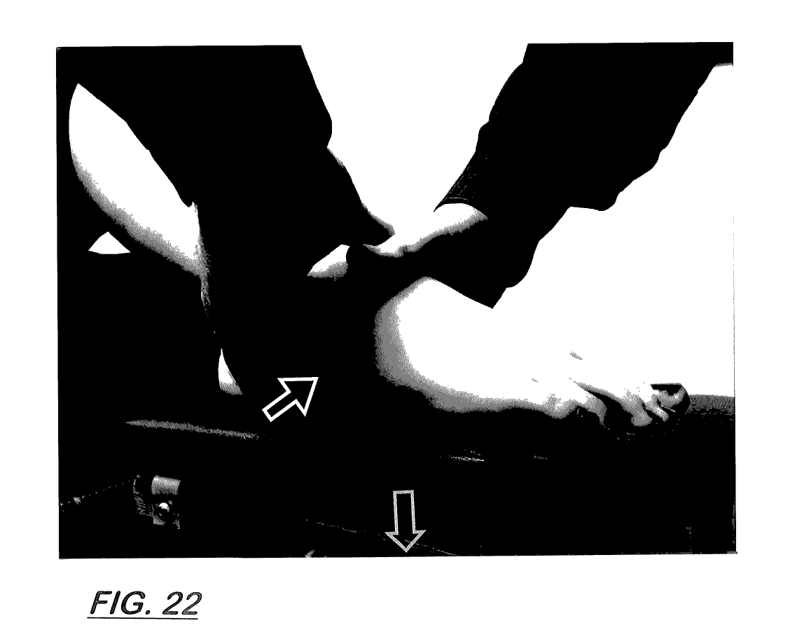

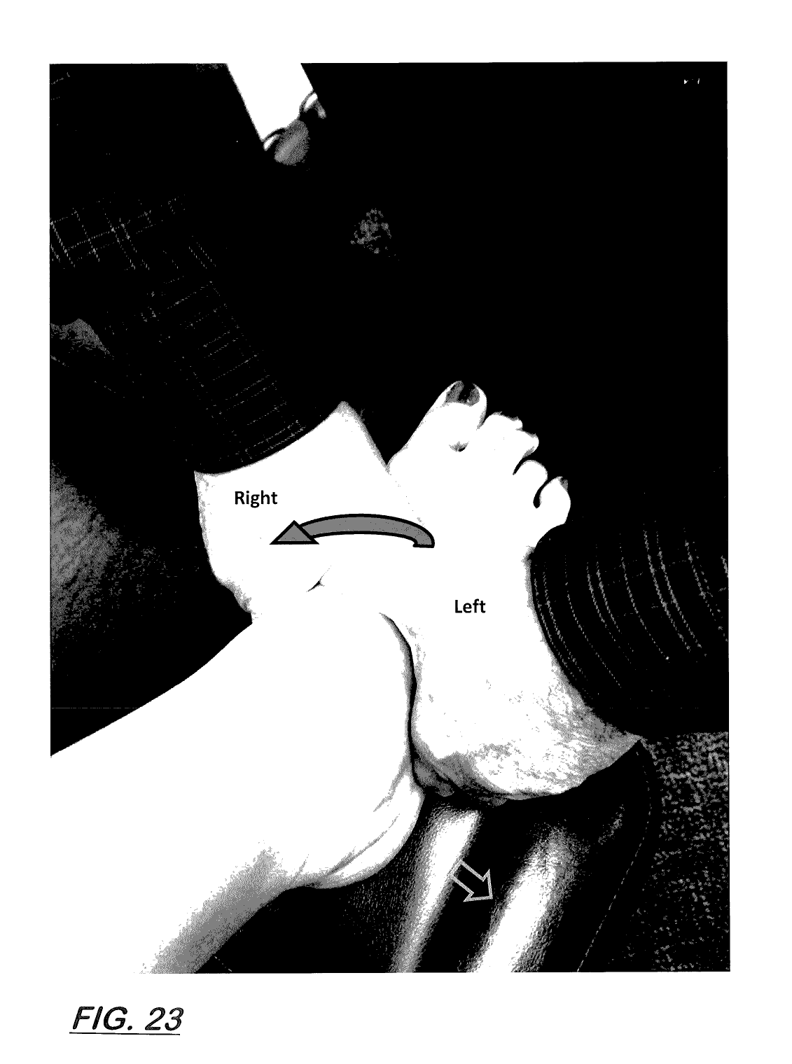

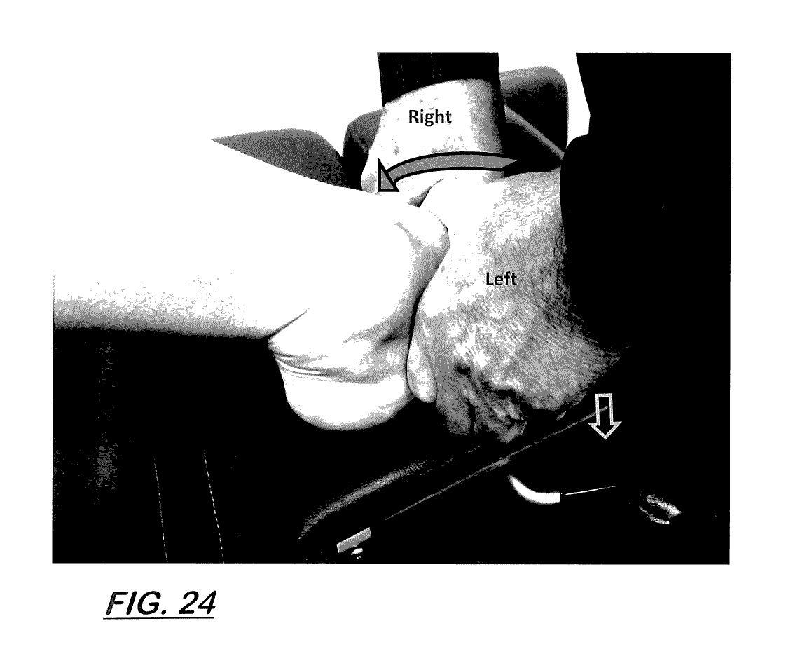

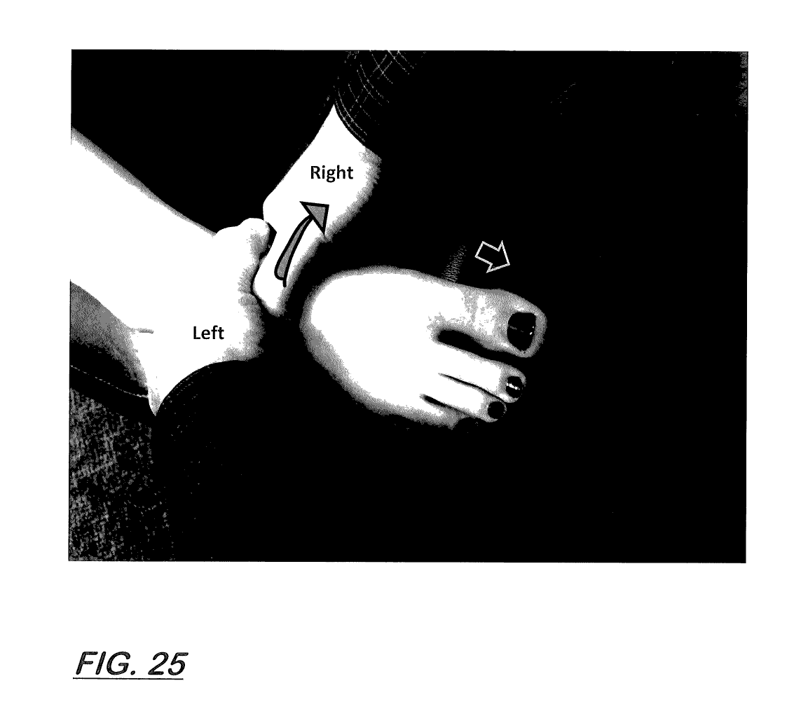

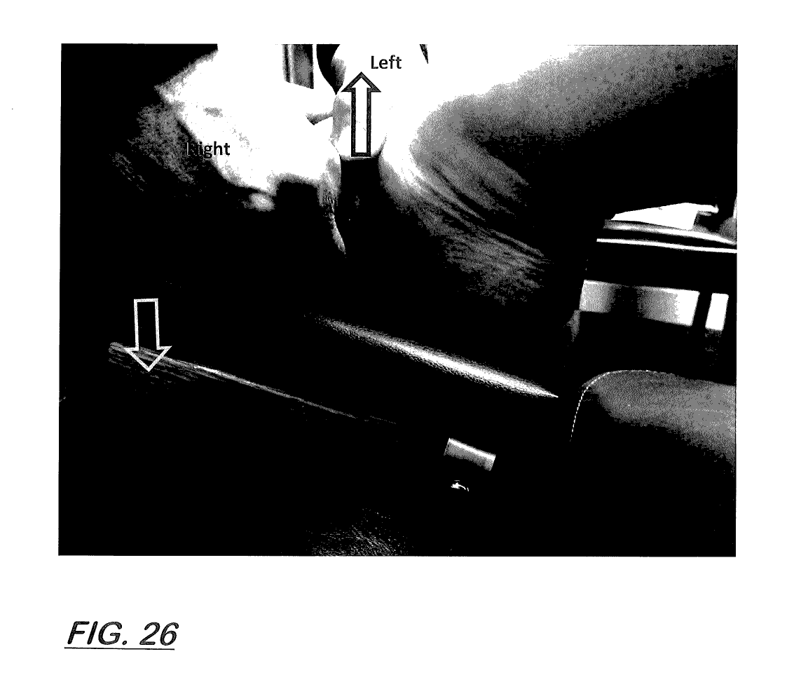

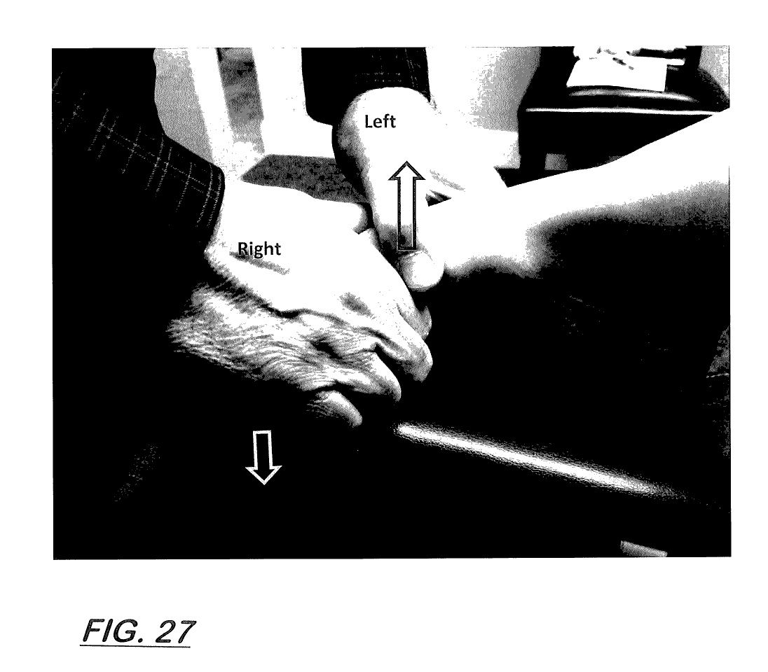

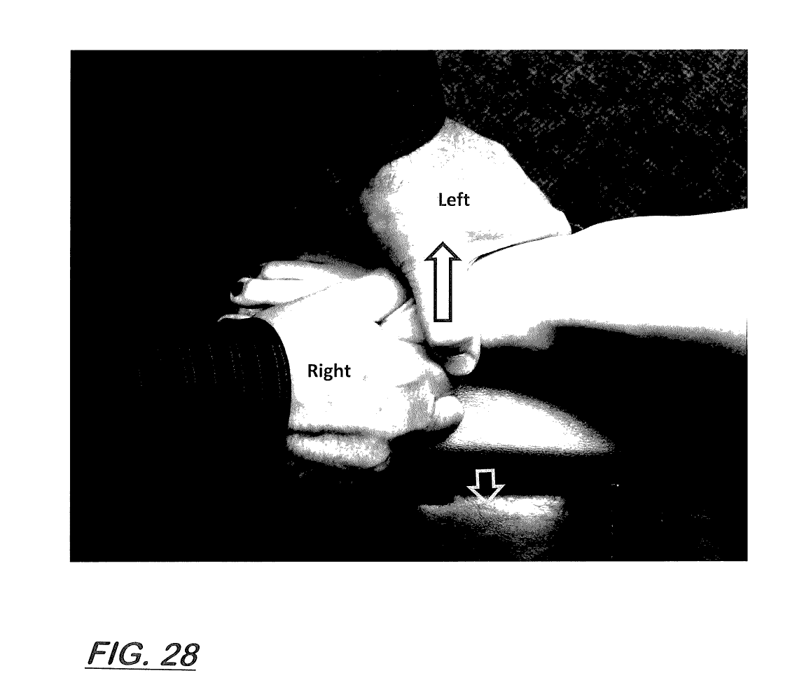

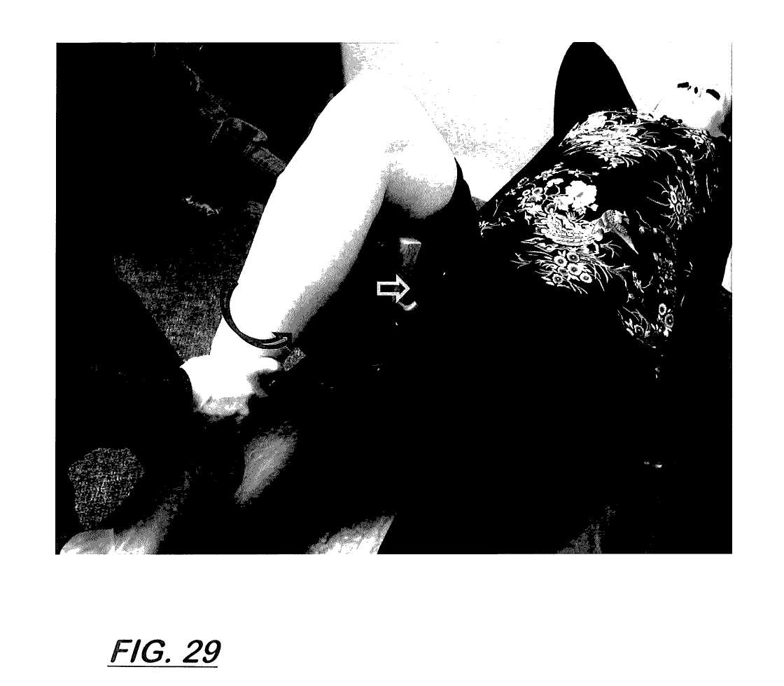

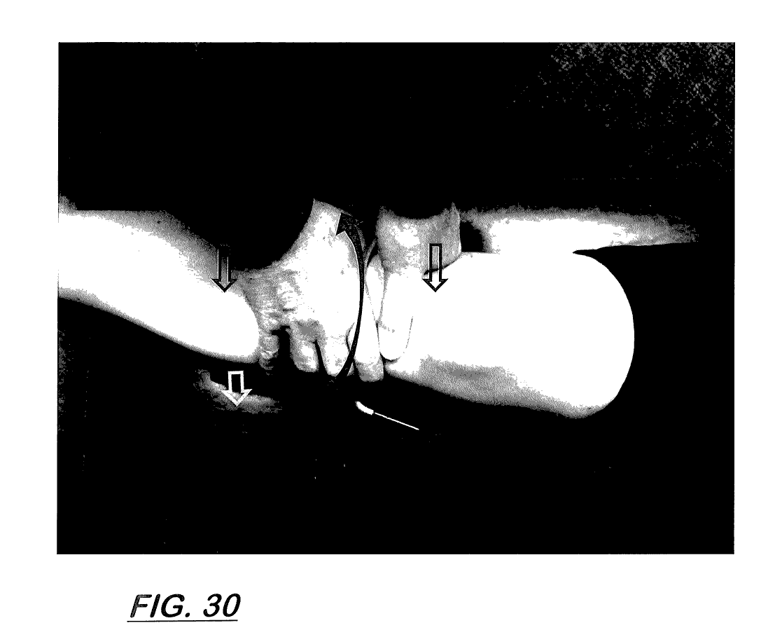

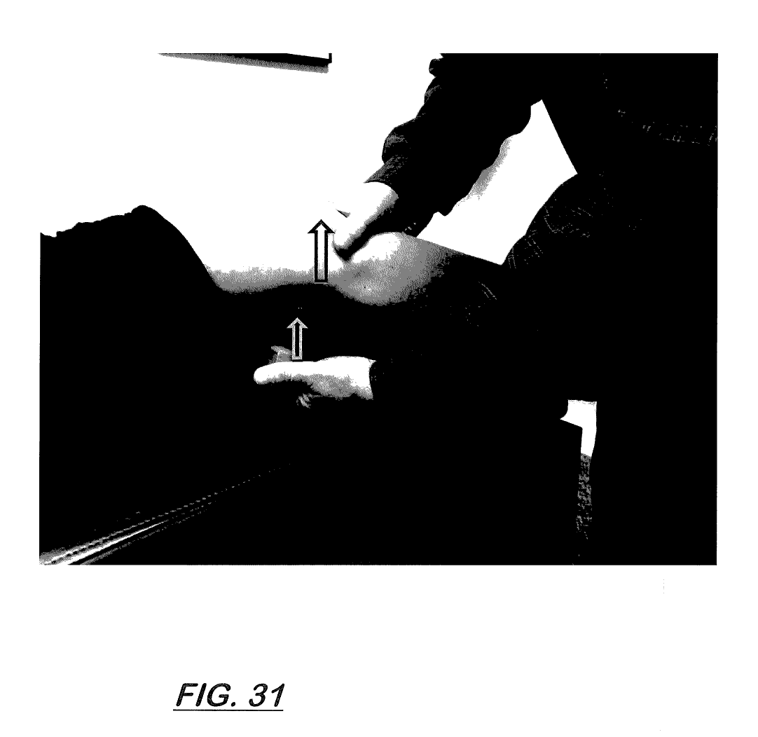

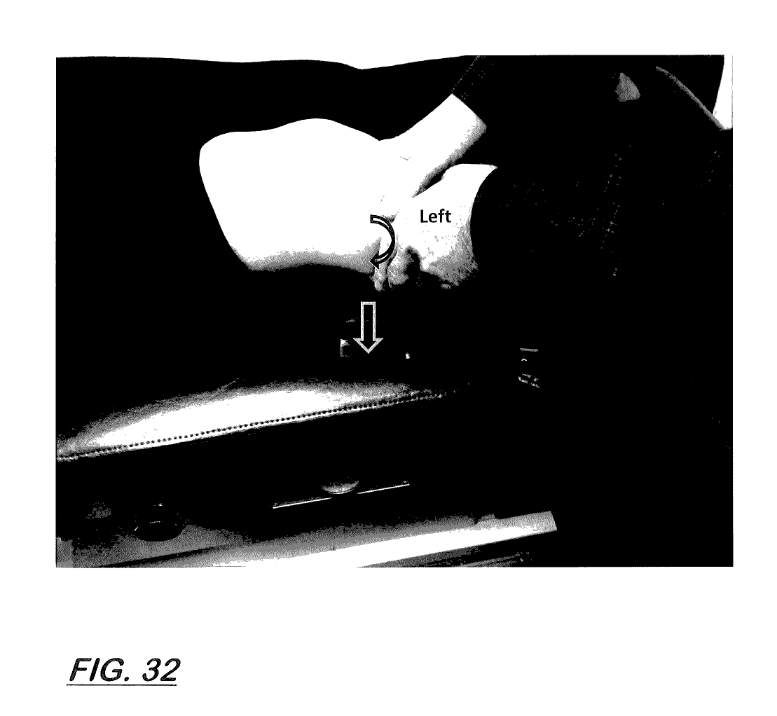

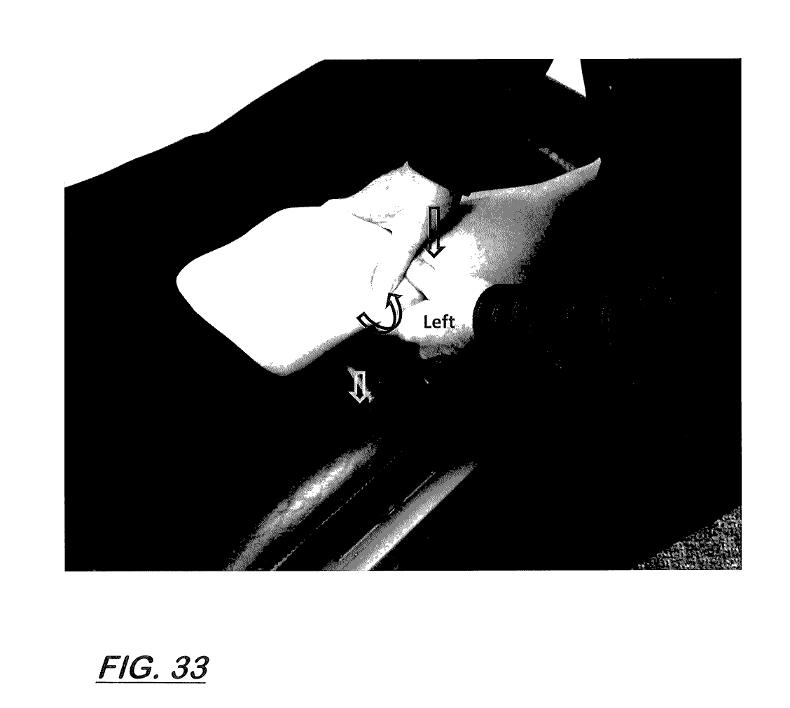

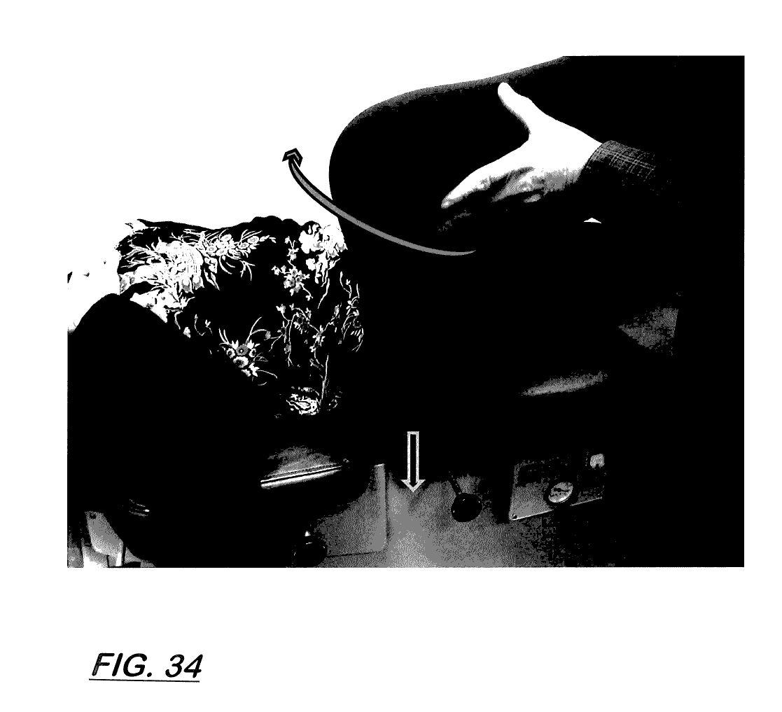

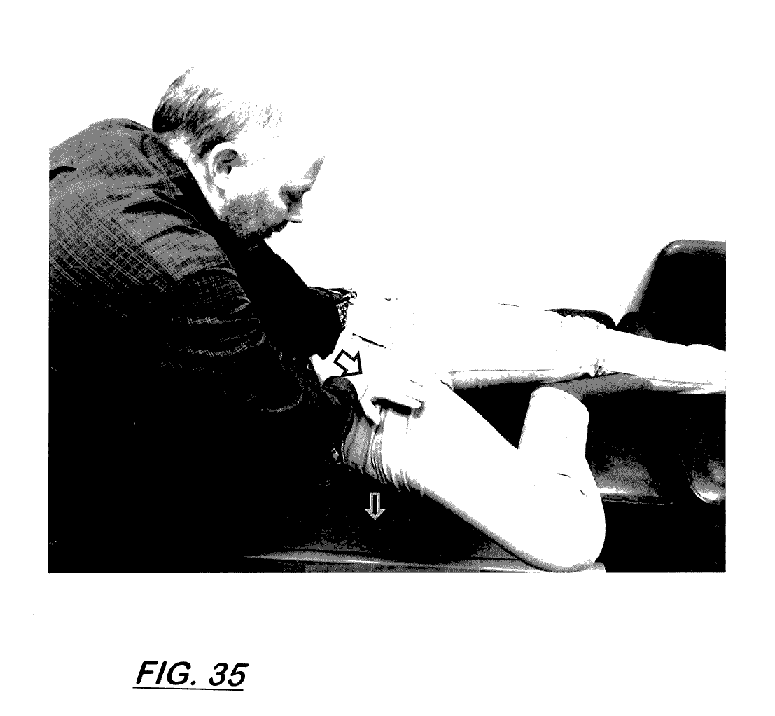

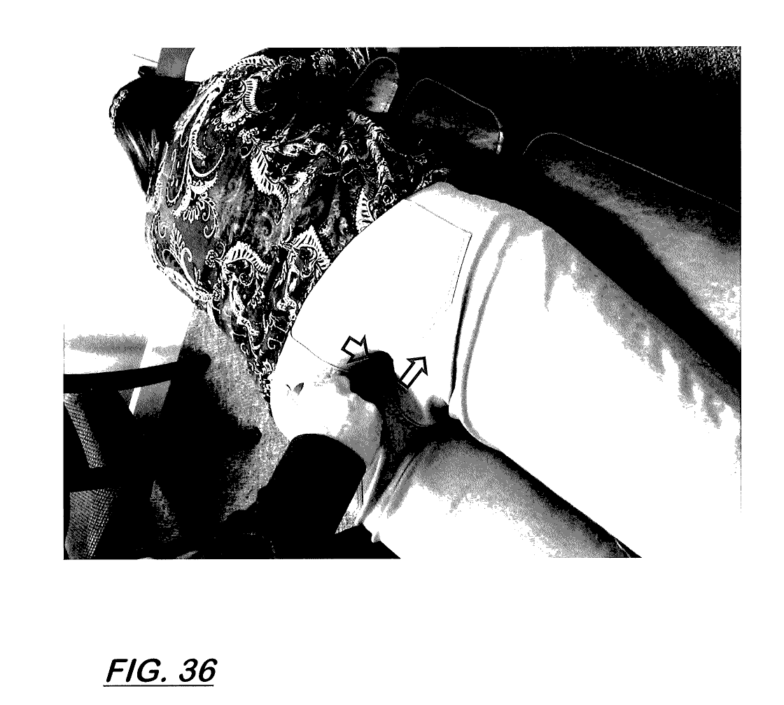

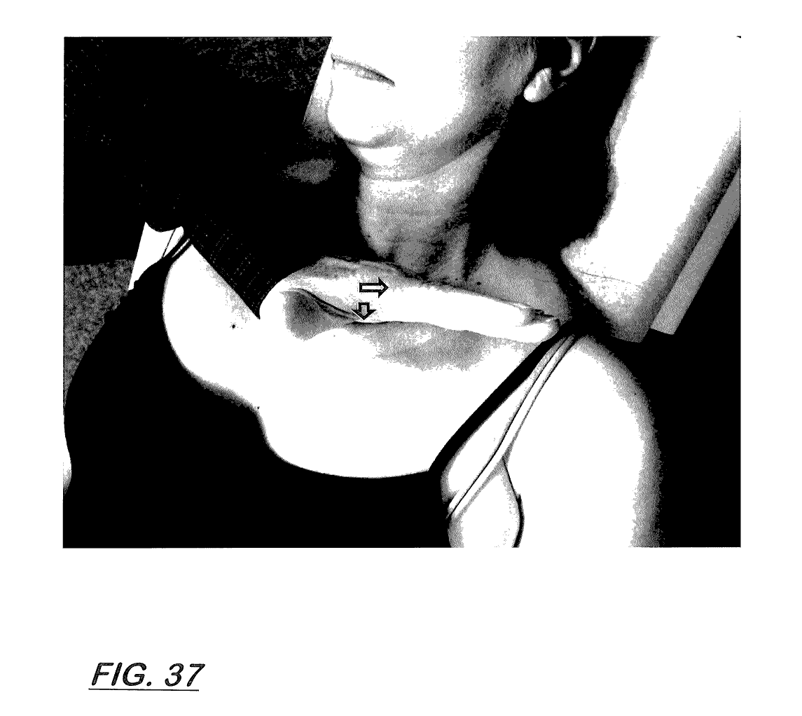

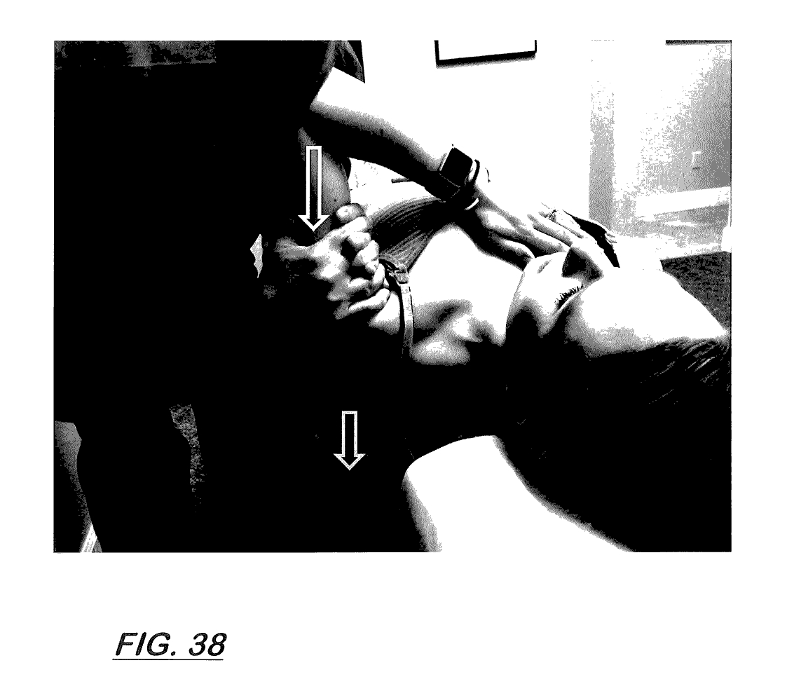

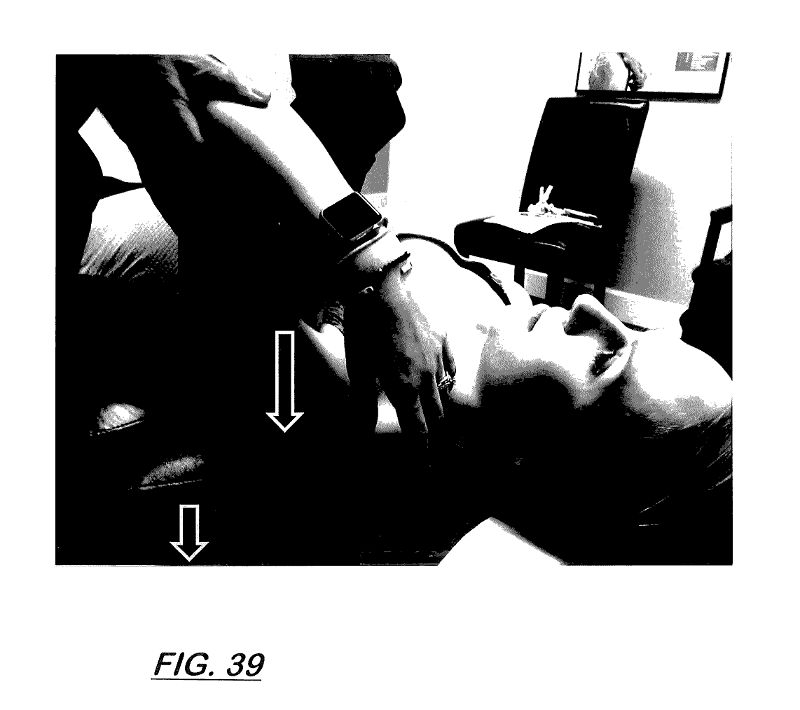

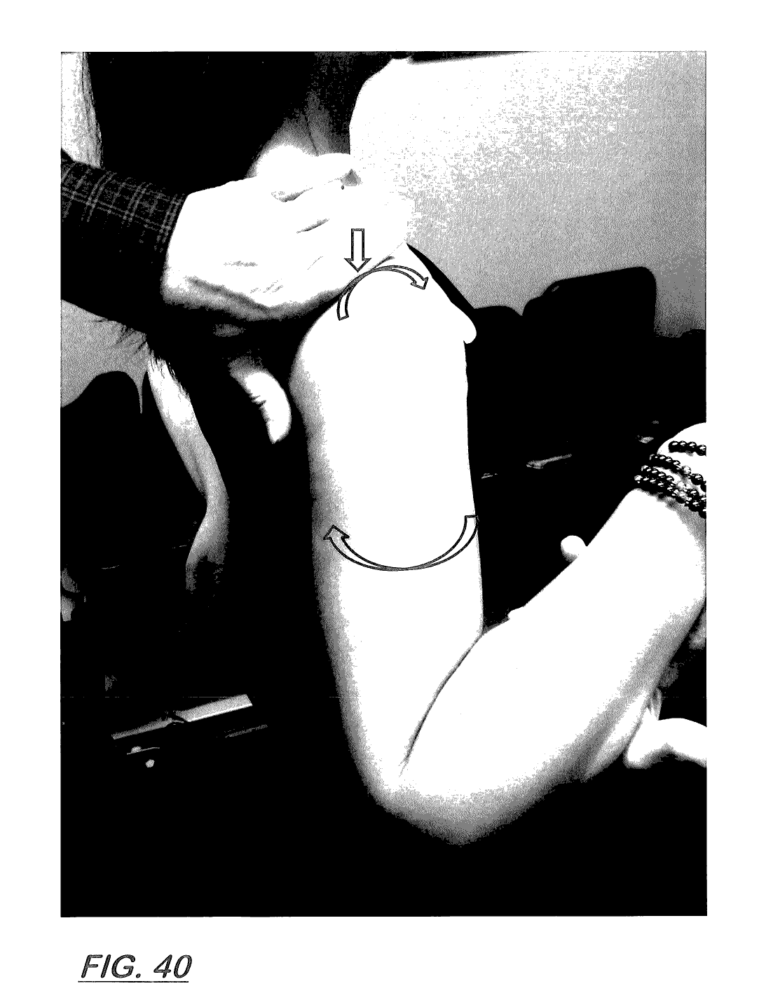

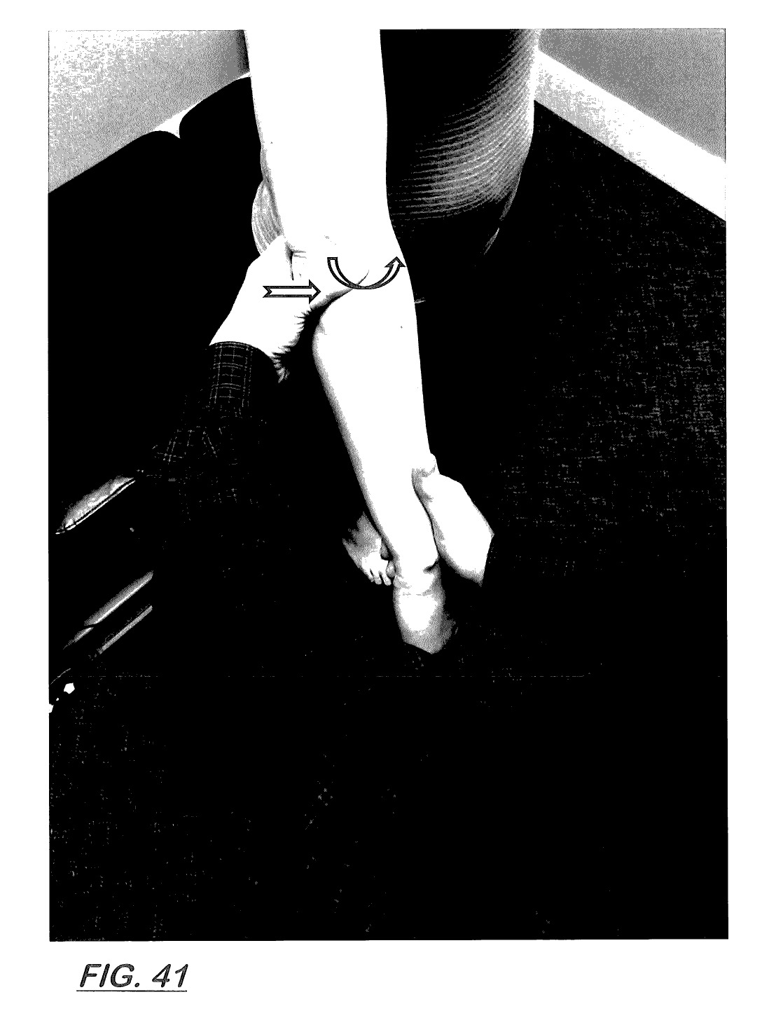

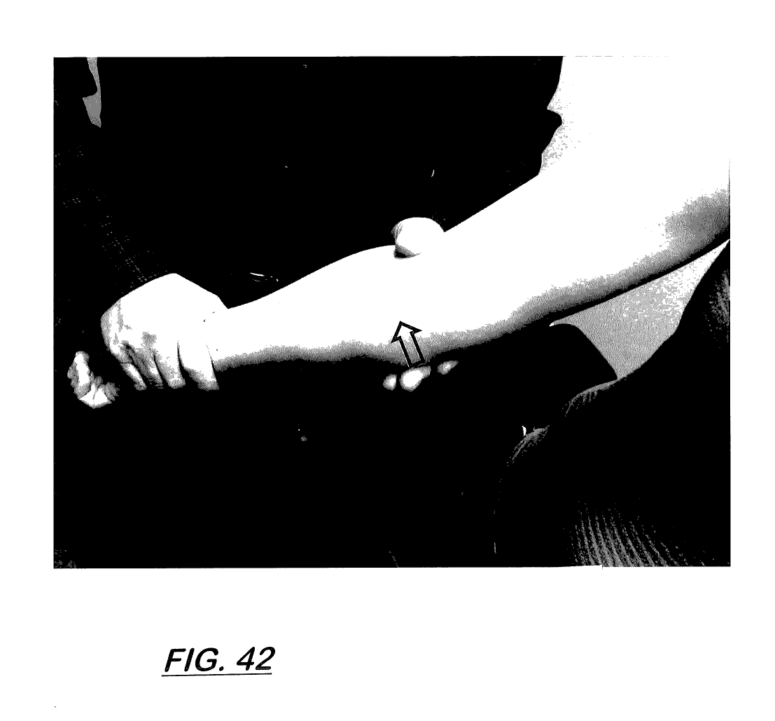

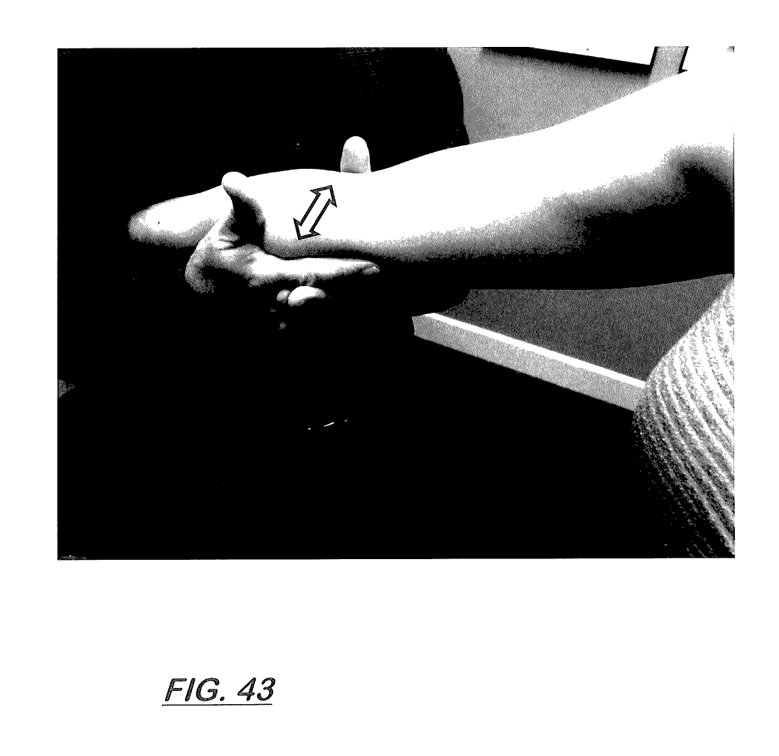

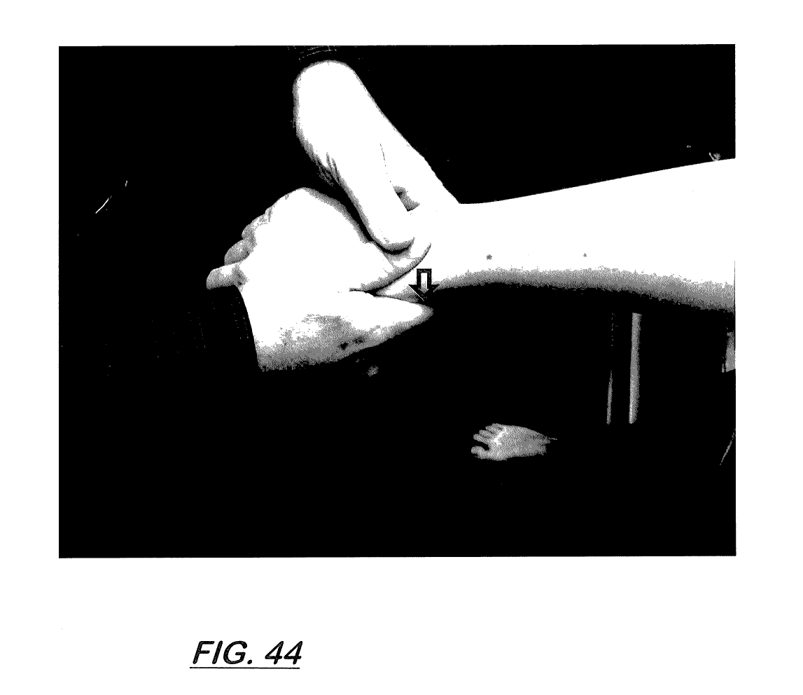

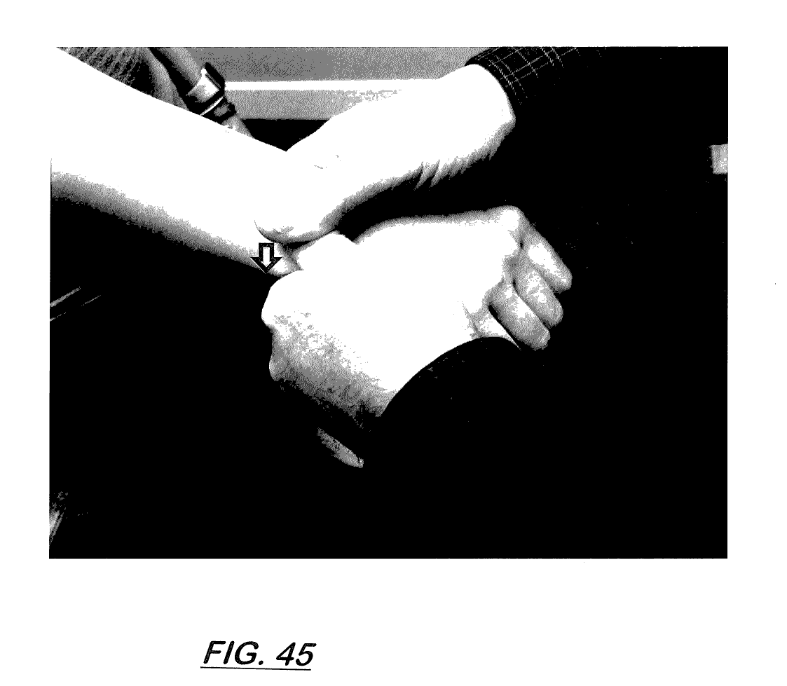

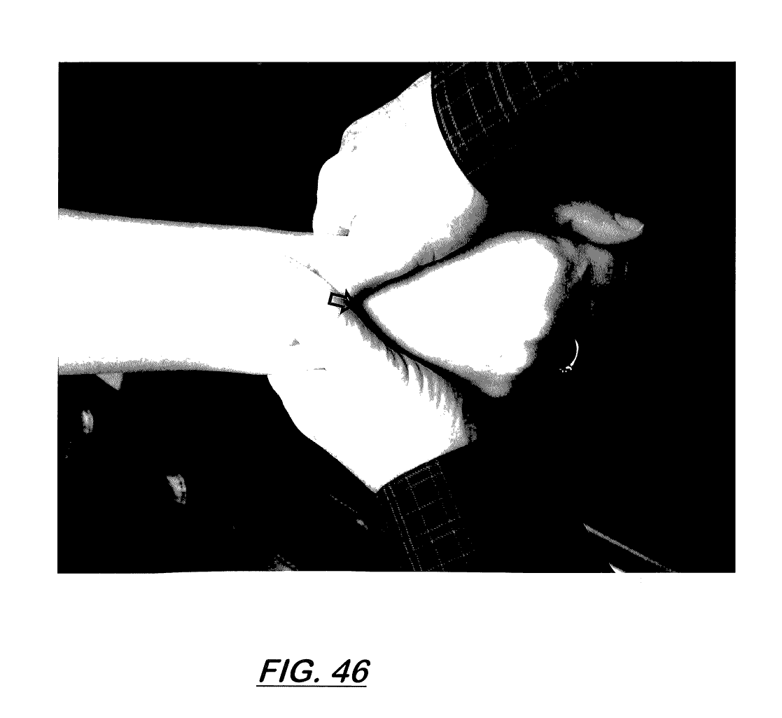

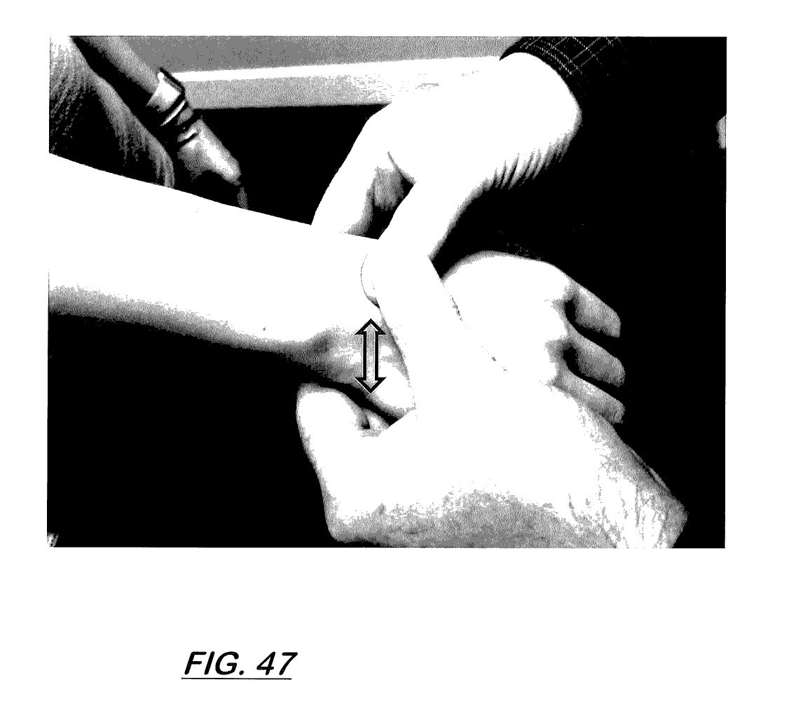

The method described above requires the physician to manually apply different functional joint manipulations shown in FIGS. 10-47.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. A method for treating a patient with one or more dysfunctional joints using manual manipulation by an practitioner, comprising the following steps:
determining the dominant and non-dominant side of a patient's body;
manually administering to a patient's body a primary treatment cycle that includes nine restorative joint articulations each applied one treatment session sequentially from the patient's dominant-side foot, the dominant-side knee, the dominant-side hip, the dominant-side pubic symphysis, the dominate side sacro-tuberous ligament, the contralateral proximal clavicle, the contralateral shoulder, the contralateral elbow, and ending at the contralateral wrist;
manually administering to the patient's body a secondary treatment cycle that includes nine functional joint manipulations each applied on one treatment session sequentially being beginning at the non-dominate foot and moving upward and towards the patient's upper body contralateral shoulder, arm and wrist; and,
repeating the primary treatment cycle.

2. The method as recited in claim 1 further including at least one overnight sleep period between functional joint manipulations.
